(19) United States
(12) Patent Application Publication
(10) Pub. No.: US 2026/0336928 A1
(43) Pub. Date: Oct. 29, 2026

(54) AUTOMATIC STORAGE AND RETRIEVAL SYSTEM HAVING STACKED CONTAINER BASED STORAGE

(71) Applicant: WALMART APOLLO, LLC, Bentonville, AR (US)

(72) Inventors: William J. FOSNIGHT, Windham, NH (US); Alan GRANT, Nashua, NH (US); Christopher HOFMEISTER, Hampstead, NH (US); Frederick M MORGAN, Bedford, NH (US); Mark SOLOMON, Wilmington, MA (US); Joshua D VALLEY, Wilmington, MA (US); Julian WARHURST, Portsmouth, RI (US)

(21) Appl. No.: 19/079,845

(22) PCT Filed: Sep. 11, 2023
(86) PCT No.: PCT/US2023/032416

§ 371 Date: Mar. 14, 2025

Related U.S. Application Data
(60) Provisional application No. 63/406,534, filed on Sep. 14, 2022.

(51) Int. Cl. B65G 1/04; B65G 1/137

(52) U.S. Cl. CPC B65G 1/0414; B65G 1/1375; B65G 1/1378

(57) ABSTRACT

Some embodiments provide an automated order fulfillment facility, comprising: a multi-level storage structure comprising a plurality of racks, and a mobile robot configured to transport totes to and from the multi-level storage structure. The mobile robot can comprise: a transport system configured to transport the mobile robot, a frame mounted on the transport system, a plurality of support locations vertically oriented within the frame, a first tote handling device comprising a first portion configured to extend from the frame and acquire a first tote from the multi-level storage structure, and a second tote handling device comprising a second portion configured to extend from the frame and support one or more totes second totes above the first tote as the first tote is being acquired.

### CROSS-REFERENCE TO RELATED APPLICATION

This application is the National Stage of International Application No. PCT/US 2023/032416, having an International filing date of 11 Sep. 2023, which designated the United States of America, and which International Application was published under PCT Article 21 (2) as WO Publication No. 2024/059007, and which claims priority from and the benefit of U.S. Provisional Application Number 63/406,534, filed Sep. 14, 2022, which is incorporated herein by reference in its entirety.

### BACKGROUND

An order fulfillment system for use in supply chains, for example in retail supply chains, may fulfill orders for individual product units or goods. Conventional systems may transfer totes including inventory using mobile robots between a storage structure and one or more picking workstations where orders are processed by a picker sequentially picking from inventory or product totes to order totes that contain eaches picked making up a given order. Storage structures in conventional systems may have individual shelves for tote storage where in addition to the weight of the totes and the payloads within the totes, the structure must support and react to seismic loading.

### BRIEF DESCRIPTION OF DRAWINGS

Disclosed herein are embodiments of systems, apparatuses, methods and processes pertaining to order fulfillment. This description includes drawings, wherein:

FIG. 1 shows a perspective view of an exemplary order fulfillment facility showing a storage structure including a number of bays of storage locations, in accordance with some embodiments.

FIG. 2 shows an isometric view of an exemplary mobile robot, in accordance with some embodiments.

FIG. 3 shows an isometric view of an exemplary mobile robot, in accordance with some embodiments.

FIG. 4 shows an isometric view of an exemplary mobile robot interfacing with an exemplary stack of totes, in accordance with some embodiments.

FIGS. 5A-5C show front, side and perspective views, respectively, of an exemplary mobile robot interfacing with an exemplary stack of totes, in accordance with some embodiments.

FIGS. 6A-6B shows front and side views respectively of exemplary mobile robots, in accordance with some embodiments.

FIGS. 7A-7B show front and side views respectively of exemplary mobile robots, in accordance with some embodiments.

FIG. 8 shows an exemplary tote transport robot and exemplary storage rack having stacks totes stored therein, in accordance with some embodiments.

FIG. 9 shows a perspective view of an exemplary tote transport robot, exemplary storage rack having stacks of exemplary totes stored therein and an exemplary workstation, in accordance with some embodiments.

FIG. 10 shows an isometric view of an exemplary workstation with exemplary robots interfacing with workstation, in accordance with some embodiments.

FIG. 11 shows an exemplary stack of exemplary totes as part of exemplary storage section accessible by robots, in accordance with some embodiments.

FIG. 12 show an isometric view of an exemplary tote transport robot, in accordance with some embodiments.

FIGS. 13-26 show an exemplary mobile robot implementing an exemplary picking operation, an in accordance with some embodiments.

FIG. 27 shows a perspective view of an exemplary workstation, in accordance with some embodiments.

FIG. 28 shows a perspective view of an exemplary tote supporting floor structure and exemplary tote engagement to tote supporting floor structure, in accordance with some embodiments.

FIG. 29 shown exemplary guide wheels on the side of an exemplary bot entering a C channel track, in accordance with some embodiments.

FIGS. 30A-30C show side, upper perspective and lower perspective views respectively of exemplary totes, in accordance with some embodiments.

FIG. 31 shows an exemplary mobile robot picking an exemplary stack of exemplary totes as well as a target tote from an exemplary stack of totes that are supported on an exemplary tote supporting floor structure, in accordance with some embodiments.

FIG. 32 shows an exemplary mobile robot interfacing with an exemplary tote storage, in accordance with some embodiments.

FIG. 33 shows an isometric view of an exemplary mobile robot, in accordance with some embodiments.

FIG. 34 shows an isometric view of an exemplary tote storage structure, in accordance with some embodiments.

FIG. 35 illustrates two opposing exemplary storage structures forming an aisle therebetween, in accordance with some embodiments.

FIG. 36 shows an exemplary mobile robot utilizing exemplary pinions and counterwheels of exemplary traction drives to engage rails, in accordance with some embodiments.

FIG. 37 shows an exemplary mobile robot utilizing exemplary pinions and counterwheels of exemplary traction drives to climb rails, in accordance with some embodiments.

FIG. 38 shows an exemplary mobile robot utilizing exemplary drive wheels of exemplary traction drives to horizontally move to a target tote on horizontal rails, in accordance with some embodiments.

FIG. 39 show a lower isometric view of an exemplary mobile robot, in accordance with some embodiments.

FIG. 40 shows an exemplary tote with exemplary climbing features, in accordance with some embodiments.

FIG. 41 shows an exemplary tote climbing bot climbing within an exemplary tote storage structure, in accordance with some embodiments.

FIGS. 42-43 show an isometric and top view respectively of an exemplary tote storage structure, in accordance with some embodiments.

FIG. 44 shows an exemplary tote climbing bot climbing within an exemplary tote storage structure, in accordance with some embodiments.

FIG. 45 shows an exemplary tote climbing bot climbing within an exemplary tote storage structure, in accordance with some embodiments.

FIG. 46 shows an exemplary tote climbing bot entering an exemplary mobile robot access point, in accordance with some embodiments.

FIG. 47 shows an exemplary tote climbing bot passing through an exemplary mobile robot access point, in accordance with some embodiments.

FIG. 48 shows an exemplary tote climbing bot passed through an exemplary mobile robot access point with exemplary climbing pinions in a climbing position, in accordance with some embodiments.

FIG. 49 shows an exemplary tote storage structure coupled to an exemplary tote storage structure, in accordance with some embodiments.

FIG. 50 show an isometric view of multiple exemplary tote storage structures, in accordance with some embodiments.

FIG. 51 show a top view of multiple exemplary tote storage structures of an exemplary tote storage structure, in accordance with some embodiments.

FIG. 52 shows an exemplary mobile robot with exemplary pinions retracted, with exemplary upper tote stack lift arm and an exemplary lower tote transfer arm retracted, in accordance with some embodiments.

FIG. 53 illustrates an exemplary mobile robot with exemplary pinions in exemplary extend positions configured to engage mating rack features, in accordance with some embodiments.

FIG. 54 illustrates an exemplary mobile robot with exemplary upper lift arm extended, in accordance with some embodiments.

FIG. 55 shows an exemplary mobile robot with an exemplary lower tote transfer arm extended, in accordance with some embodiments.

FIG. 56 shows an exemplary robot with an exemplary lower tote transfer arm, in accordance with some embodiments.

FIG. 57 shows an exemplary robot with an exemplary lower tote transfer arm being retracted, in accordance with some embodiments.

FIGS. 58-59 illustrate an exemplary robot with an exemplary lower tote transfer arm being rotated, in accordance with some embodiments.

FIG. 60 illustrates an exemplary robot with an exemplary lower tote transfer arm extended at a first elevation, in accordance with some embodiments.

FIG. 61 shows the exemplary robot of FIG. 60 with the exemplary lower tote transfer arms extended and at a second elevation, in accordance with some embodiments.

FIG. 62 shows an exemplary robot with an exemplary tote transfer arm retracted, in accordance with some embodiments.

FIG. 63 shows an exemplary robot with an exemplary tote stack lift arm in a retracted position, in accordance with some embodiments.

FIG. 64 shows a bottom isometric view of an exemplary mobile robot, in accordance with some embodiments.

FIG. 65A illustrates an exemplary robot with exemplary climbing pinions in a retracted position, in accordance with some embodiments.

FIGS. 65B-65C show the exemplary robot of FIG. 65A with an exemplary drive gear and motor moved in a Z direction with additional exemplary pinions being pushed out to an extended position, in accordance with some embodiments.

FIGS. 66-72 show an exemplary mobile robot retrieving an exemplary tote from exemplary tote stacks in storage, in accordance with some embodiments.

FIG. 73 shows an isometric view of an exemplary mobile robot, in accordance with some embodiments.

FIG. 74 show an isometric view of a portion of an exemplary transport and climbing mechanism, in accordance with some embodiments.

FIG. 75 shown an isometric view of an exemplary tote configured to be compatible with a transport and climbing mechanism of a robot, in accordance with some embodiments.

FIG. 76 shows an isometric view of an exemplary transport and climbing mechanism configuration to drive on a surface or deck with exemplary climbing sprockets in a retracted position and exemplary drive wheels in a retracted or driven in position, in accordance with some embodiments.

FIGS. 77-78 shown isometric and top views respectively of an exemplary transport mechanism travelling on exemplary totes, in accordance with some embodiments.

FIGS. 79-80 show isometric and top views respectively of an exemplary transport mechanism travelling on exemplary totes, in accordance with some embodiments.

FIGS. 81-82 show isometric and top views respectively of an exemplary transport mechanism travelling on exemplary totes, in accordance with some embodiments.

FIGS. 83-85 show top, side and end views respectively of an exemplary tote transport robot, in accordance with some embodiments.

FIGS. 86-87 show top and isometric views respectively of an exemplary transport mechanism transport mechanism with exemplary drive wheels retracted and exemplary pinions extended engaging exemplary totes, in accordance with some embodiments.

FIG. 88 shows a top view of an exemplary transport and climbing mechanism configuration to drive on a surface or deck with exemplary climbing sprockets in a retracted position and exemplary drive wheels in a retracted or driven in position, in accordance with some embodiments.

FIG. 89 shows an exemplary tote or container having features configured to interface with a transport mechanism, in accordance with some embodiments.

FIGS. 90-91 show isometric views of an exemplary tote, in accordance with some embodiments.

FIG. 92 shows exemplary totes stacked with rows of exemplary tote stacks, in accordance with some embodiments.

FIG. 93 show exemplary totes stacked with rows of tote stacks and forming exemplary aisles, in accordance with some embodiments.

FIGS. 94-95 show isometric and exploded views of exemplary totes, in accordance with some embodiments.

FIG. 96 shows an end view of an exemplary storage structure with an exemplary tote climber bot traversing on rails of exemplary totes, in accordance with some embodiments.

FIG. 97 shows an exemplary tote climber bot traversing on the rails of exemplary totes and also illustrates exemplary tote climber bots on exemplary transit planes, in accordance with some embodiments.

FIG. 98 show an isometric view of an exemplary tote transport robot with one or more exemplary casters, in accordance with some embodiments.

FIGS. 99-100 shows end and isometric views respectively of an exemplary transport bot traversing on the rails of exemplary totes, in accordance with some embodiments.

FIG. 101 shows exemplary tote climber bots and exemplary dynamic and static workstations, in accordance with some embodiments.

FIG. 102 shows an isometric view of an exemplary vertical swap bot, in accordance with some embodiments.

FIGS. 103-104 show elevation and perspective views respectively of exemplary tote climber bots having exemplary cages, in accordance with some embodiments.

FIG. 105 illustrates an exemplary tote climber bot on rails of exemplary totes, in accordance with some embodiments.

FIG. 106 illustrates an exemplary tote climber bot with exemplary upper guide wheels, in accordance with some embodiments.

FIGS. 107A-107C show perspective, end and top views respectively of an exemplary transport mechanism implemented with exemplary climbing belts having climbing features, in accordance with some embodiments.

FIGS. 108A-108C illustrate an exemplary bot with exemplary drive wheels retracted and exemplary climbing belts extended, in accordance with some embodiments.

FIGS. 109A-109B illustrate an exemplary bot with an exemplary transport mechanism having exemplary drive wheels retracted and exemplary climbing belts extended, in accordance with some embodiments.

FIGS. 110A-110B illustrate an exemplary bot with an exemplary lift arm and tote exemplary transfer arm, in accordance with some embodiments.

FIGS. 111A-111B illustrate an exemplary bot with exemplary drive wheels extended and exemplary climbing belts retracted, in accordance with some embodiments.

FIGS. 112A-112B show front and perspective views respectively of an exemplary tote transfer robot, in accordance with some embodiments.

FIGS. 113-114 shown an exemplary tote dolly loading station, in accordance with some embodiments.

FIGS. 115-116 show an exemplary tote dolly loading station with exemplary robots loading exemplary totes, in accordance with some embodiments.

FIGS. 117-118 show top and bottom perspective views respectively of an exemplary tractor feed tote, in accordance with some embodiments.

FIG. 119 shows an exemplary stack of three exemplary tractor feed totes, in accordance with some embodiments.

FIG. 120 illustrate a partial view of an exemplary feed tote with vertical holes configured to be engagement by a robot, in accordance with some embodiments.

FIG. 121 shows a stack of exemplary totes and an exemplary base, in accordance with some embodiments.

FIG. 122 illustrates exemplary tote stacks each cooperated with an exemplary base, in accordance with some embodiments.

FIG. 123 shows an exemplary climber extractor robot, in accordance with some embodiments.

FIG. 124 illustrates an exemplary lower frame of an exemplary climber extractor robot with exemplary tractor feeds or gears, in accordance with some embodiments.

FIGS. 125-126 illustrate exemplary tractor feeds, in accordance with some embodiments.

FIG. 127 shows an exemplary lower frame anchored to an exemplary tote stack, in accordance with some embodiments.

FIG. 128 illustrates the exemplary lower frame of FIG. 127 with exemplary pins engaged, in accordance with some embodiments.

FIG. 129 illustrates exemplary leadscrews of an exemplary climber extractor robot activated lifting an exemplary upper frame, in accordance with some embodiments.

FIG. 130 illustrates an exemplary climber extractor robot flexibly coupled with an exemplary upper frame enabling lifting of the climber extractor robot, in accordance with some embodiments.

FIG. 131 illustrates the exemplary climber extractor robot of FIG. 130 with an upper carriage driven further vertically, in accordance with some embodiments.

FIG. 132 illustrates an exemplary climber extractor robot extracting an exemplary tote, in accordance with some embodiments.

FIG. 133 illustrate the exemplary climber extractor robot of FIG. 132 with the upper frame lowered, in accordance with some embodiments.

FIGS. 134-135 illustrate an exemplary climber extractor robot operating with an exemplary mobile robot, in accordance with some embodiments.

FIGS. 136-137 show an exemplary climber with exemplary drive wheels and exemplary casters, in accordance with some embodiments.

FIGS. 138A-138F illustrate an exemplary sequence of an exemplary bot driving down an exemplary aisle, engaging and climbing an exemplary stack of exemplary totes, retrieving an exemplary tote, and moving down the aisle, in accordance with some embodiments.

FIG. 139 shows an exemplary shipping container, in accordance with some embodiments.

FIG. 140 shows stacks of exemplary shipping containers, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Embodiments of the present technology will now be described with reference to the figures, which in general relate to an automatic storage and retrieval system having stacked container-based storage. The embodiments described enable a higher level of storage density of totes. Further and as will be described, the embodiments are intended to enable more efficient use of structure related to container or tote storage.

It is understood that the present embodiments may be embodied in many different forms and should not be construed as being limited to the embodiments set forth herein. Rather, these embodiments are provided so that this disclosure will be thorough and complete and will fully convey the invention to those skilled in the art. Indeed, the embodiments are intended to cover alternatives, modifications and equivalents of these embodiments, which are included within the scope and spirit of the invention as defined by the appended claims. Furthermore, in the following detailed description, specific details are set forth in order to provide an understanding of the present embodiments.

The terms “top” and “bottom,” “upper” and “lower” and “vertical” and “horizontal” as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application. In one non-limiting embodiment, the acceptable manufacturing tolerance is ±0.25%.

For purposes of this disclosure, a connection may be a direct connection or an indirect connection (e.g., via one or more other parts). In some cases, when a first element is referred to as being connected, affixed or coupled to a second element, the first and second elements may be directly connected, affixed or coupled to each other or indirectly connected, affixed or coupled to each other. When a first element is referred to as being directly connected, affixed or coupled to a second element, then there are no intervening elements between the first and second elements (other than possibly an adhesive or weld used to connect, affix or couple the first and second elements).

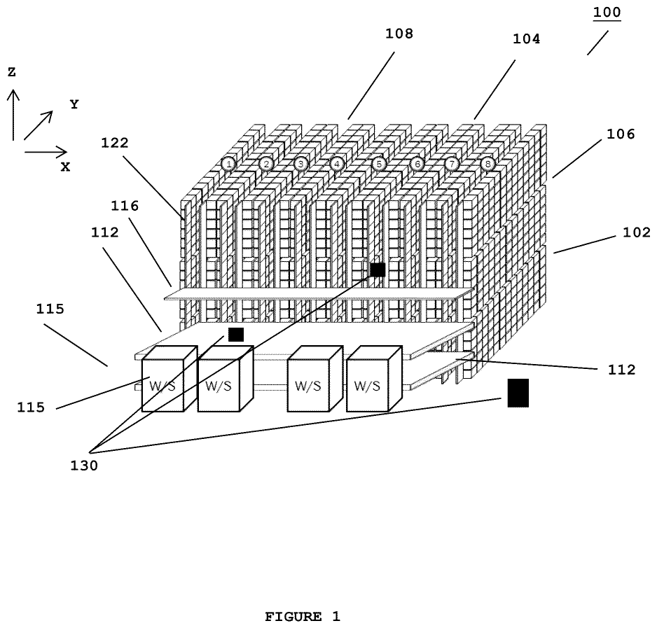

FIG. 1 shows a perspective view of an exemplary order fulfillment facility 100 showing a storage structure 102 including a number of bays 104 of storage locations 106, in accordance with some embodiments. The bays 104 each include a y-z array of storage locations 106 in horizontal rows and level changing towers along the rows which in embodiments may be vertical towers. In alternate aspects, the vertical towers may not be provided, for example, where mobile robots climb within the storage locations as will be described. Mobile robots 130 may travel between storage levels in the z-direction. The pairs of bays 104 that are arranged to face each other may be separated by aisles 108. An aisle 108 may have a width such that a mobile robot 130 traveling within an aisle 108 may transfer containers to the bays 104 on either side of the aisle 108. The order fulfillment facility 100 includes decks 112 spaced apart at different vertical levels of the storage structure 102. The decks 112 may be arranged in pairs and extend between the aisles so that robots 130 can maneuver in the x-y plane of each deck to travel between different aisles. One of the decks 112 or suitable supporting structure may also extend into the respective aisles to allow technicians to walk into an aisle 108 to service components within the aisle. In alternate aspects, the decks may not be provided, for example, where the mobile robots travel on the floor or on a deck above storage as will be described. The order fulfillment facility 100 also includes an express deck 116 arranged to extend between the aisles so that robots 130 can maneuver in the x-y plane to travel between different aisles. Decks 112 may be provided for transit of Bots 130 between aisles or for transit of Bots 130 between aisles and workstations (such as workstations 115). Here, Express deck(s) 116 may be provided for x-direction movement, transit deck(s) 112 may be provided for Bots 130 to enter and return from the workstation 115 and transit deck(s) 112 may also be provided transit between the workstations 115 and storage structure 102. Each workstation 115 is equipped to receive pairs of one or more mobile robots as will be described. For example, a first mobile robot at a station may carry a product tote, in combination with successive mobile robots or product totes with items for fulfilling product requests to make up an order. A second mobile robot at the station may carries an order tote, in combination with successive mobile robots or successive product totes as required, within which containers of items from the product totes are placed to fulfill product requests to make up an order having one or more order totes. The containers may be bags such as plastic or paper bags. In alternate aspects, containers may be cardboard or any suitable material. Workers at a workstation manually transfer items from a product tote to a container and ultimately to the order tote under guidance of an inventory control system at the workstation. As noted above, the order fulfillment facility 100 may further include a number of mobile robots 130 for transferring totes or other product or order containers to and from workstations 115 and storage locations 106 in the bays 104. The mobile robots 130 may be self-guided and/or rail-guided so as to move horizontally and vertically within aisles 108 to transfer totes or other product containers between the mobile robots 130 and storage locations 106. For example, a track system including horizontal rails may be affixed to the bays 104 at different vertical levels. The horizontal rails provide access to storage shelves on either side of an aisle 108 in the x-direction on a given level. The bays 104 include vertical level changing towers 122 within which the mobile robots may travel vertically in the z-direction between levels of storage locations 106. In alternate aspects, rails may not be needed, for example, where mobile robots utilize features within the storage structure's totes to climb and traverse as will be described in greater detail.

Further details of the work stations, storage structure and mobile robot which may be used are described for example in the following U.S. patents and patent applications: U.S. Pat. No. 9,139,363, entitled “Automated System For Transporting Payloads,” issued Sep. 22, 2015; U.S. Pat. No. 10,435,241, entitled, “Storage and Retrieval System,” issued Oct. 8, 2019; and U.S. Pat. No. 11,142,398, entitled, “Order Fulfillment System,” issued Oct. 12, 2021. Each of these patents and applications are incorporated by reference herein in their entirety. Although order fulfillment facility 100 has been described with respect to autonomous Bots having the ability to transport totes from storage to decks to workstations and back, the workstation embodiment and disclosure regarding the operation of the workstation is not limited by the automation configurations described.

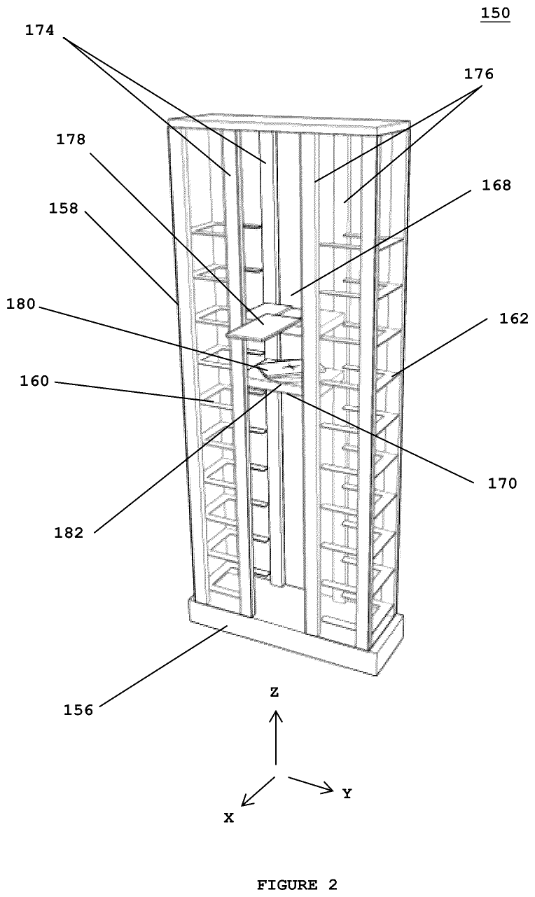

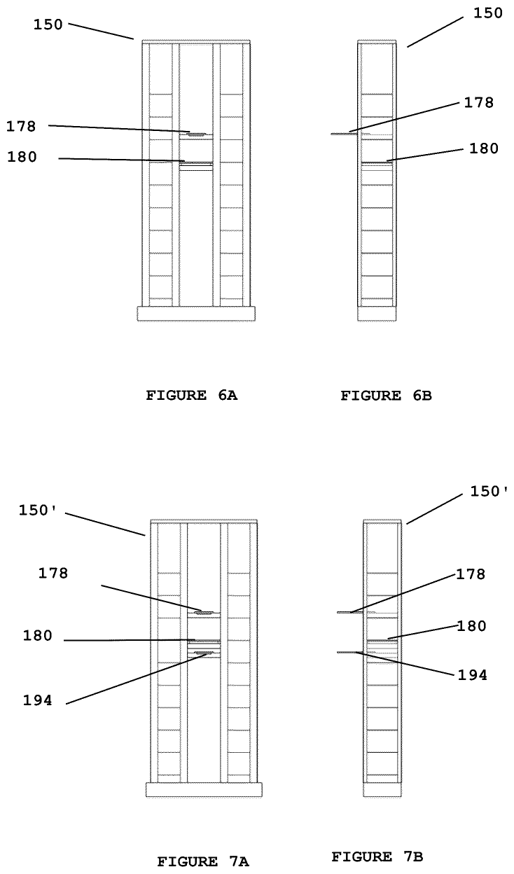

Referring now to FIG. 2 there is shown an isometric view of an exemplary mobile robot 150, in accordance with some embodiments. Referring also to FIGS. 6A-B, there are shown front and side views respectively of an exemplary mobile robot 150, in accordance with some embodiments. Mobile robot 150 as base 156 where base 156 may have features of an AMR (autonomous mobile robot). An AMR is a mobile robot platform that moves independently within a warehouse or logistics operation. The AMR may use any suitable transport and navigation system and method to navigate through the environment where the navigation method may be untethered and fully automatic or alternately may rely on predefined paths or tracks utilizing optical, magnetic or other suitable sensing of the path(s). As will be described in greater detail below mobile robot 150 may travel in direction Y down aisles of the stored structure and selectively pick and place containers for totes for transport from the stored structure to workstations and back. Mobile robot 150 further has frame 158 with opposing storage shelves 160, 162. Opposing storage shelves 160, 162 are provided within frame 158 to store and buffer totes that are transported to and from storage for picking orders at workstations as will be described. Mobile robot 150 further has 2 tote handling devices 168, 170. Each tote handling device 168, 170 is independently removable in the +/−Z direction where tote handling devices 168, 170 are coupled to frame 158 by guide rails 174, 176. Independently operable Z drives (not shown) may be provided for each tote handling device 168, 170 to be independently removable in the +/−Z direction where the Z drives may be a lead screw driven, belt driven or driven by any suitable positioning mechanism. Handling device 168 has paddle 178 that his movable in a plus or minus x-direction where paddle 178 is configured to raise or lift one or more totes as will be described in greater detail. Paddle 178 is coupled to a chassis of tote handling device 168 by rails or guides or any suitable constraining device such that paddle 178 is movable in a plus or minus x-direction. The rails or guides may be telescoping and paddle 178 may be driven by a suitable belt drive lead screw drive or other suitable mechanism to selectively position paddle 178 in a plus or minus x-direction. Similarly, handling device 170 has paddle 180 that his movable in a plus or minus x-direction but also rotationally about the Z axis where paddle 180 is configured to raise or lift one or more totes as will be described in greater detail. Paddle 180 is coupled to rotational drive 182 which is then coupled to a chassis of tote handling device 168. Paddle 180 is coupled to rotational drive 182 by rails or guides or any suitable constraining device such that paddle 180 is movable in a plus or minus x-direction when rotational drive 182 is positioned to point paddle 180 in an X direction. The rails or guides may be telescoping and paddle 180 may be driven by a suitable belt drive lead screw drive or other suitable mechanism to selectively position paddle 180 in a radial direction with respect to rotational drive 182. Rotational drive 182 may be coupled to a chassis of tote handling device 168 by suitable bearing(s) and may be servo or stepper driven by any suitable rotational drive that allows paddle 180 to be rotated about the Z axis. While tote handling device 168 is configured to lift a stack of totes, tote handling device 170 is configured to pick or place one or more totes from a stack of totes and pick or place the one or more totes from or to shelves 160, 162 for transport to or from a workstation. Within a storage area, as will be described, mobile robot 150 has an upper z-carriage 168 with a x-z-axis lift paddle 178 used to lift a tote stack above a tote to be accessed. On the same z-axis, mobile robot 150 has a lower z-carriage 170 with theta (rotation about z axis), and radial axes for picking totes to be accessed from a stack of totes, rotating, for example, +/−90 degrees or otherwise and storing on shelves 160, 162 within the mobile robot 150. The mobile robot shown has tote storage on two sides of the z-axis. In alternate aspects, the mobile robots may also be configured with storage on only one side of the z-axis, for example, to enable easier maintenance access in the event of a tote pick or place error within the storage area.

Referring now to FIG. 3 there is shown an isometric view of an exemplary mobile robot 150′, in accordance with some embodiments. Referring also to FIGS. 7A-B, there are shown front and side views respectively of exemplary mobile robots 150′, in accordance with some embodiments. Mobile robot 150′ has features similar to mobile robot 150 but where mobile robot 150′ has an additional tote handling device 192. In the embodiment shown tote handling device 192 has paddle 194 that is configured to stabilize the lower portion of a stack of totes by engaging the lower portion of the stack of totes and maintaining the X-Y position of the lower stack with respect to the upper stack that is raised to access a target tote. As such, tote handling device 192 also has a Z drive which allows tote handling device 192 to be independently positioned in the Z direction. Similarly tote handling device 192 also has a radial drive for paddle 194 that allows paddle 194 to be independently positioned in the plus or minus x-direction. Push down paddle 194 is shown on “tower bot’ 150′ where the push down paddle may also be utilized on alternate embodiments, for example, can also be applied to the tote climbing bot as will be described. This relieves the load on the climbing gear teeth when lifting the tote stack above the tote to be picked or placed as will be shown. The paddle 194 may extend and be lowered on a stack of totes but alternately can be as simple as flip down levers or any suitable mechanism to stabilize the stack of totes relative to tote transport bot 150′. Although tote handling devices 168, 192 have been described as only having X and Z axis′ of motion, in alternate aspects either or both of tote handling devices 168, 192 may have additional axis′, for example a rotary axis about Z where one or both of tote handling devices 168, 192 may be able to pick and place totes or stacks of totes to and from storage and also to and from storage nests on bot 150′.

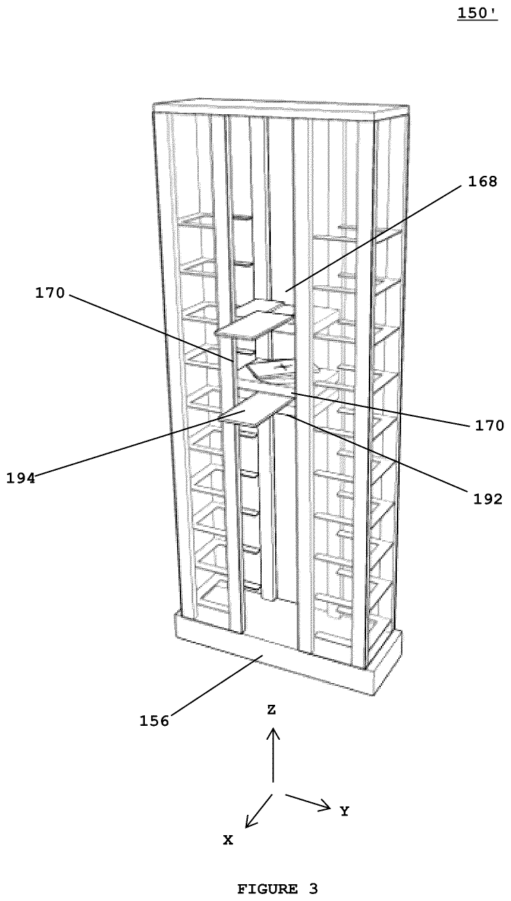

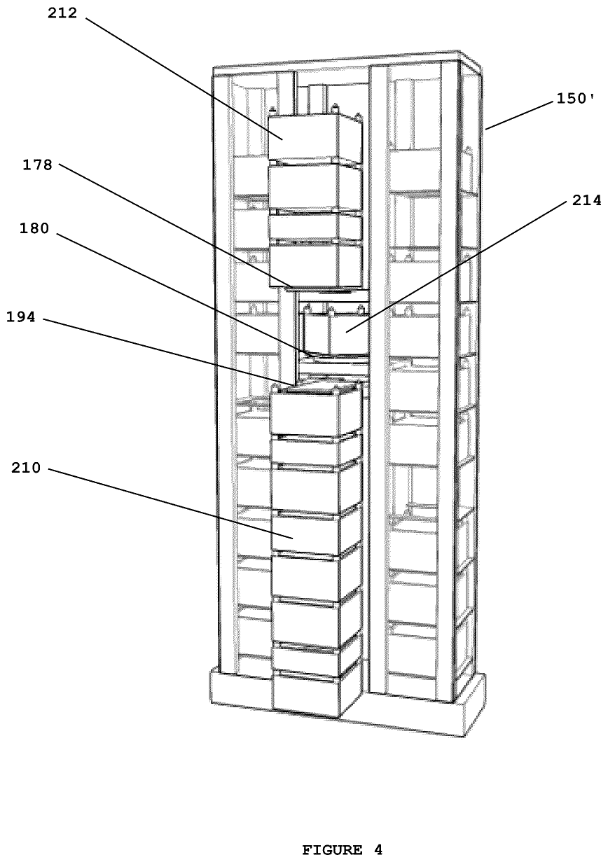

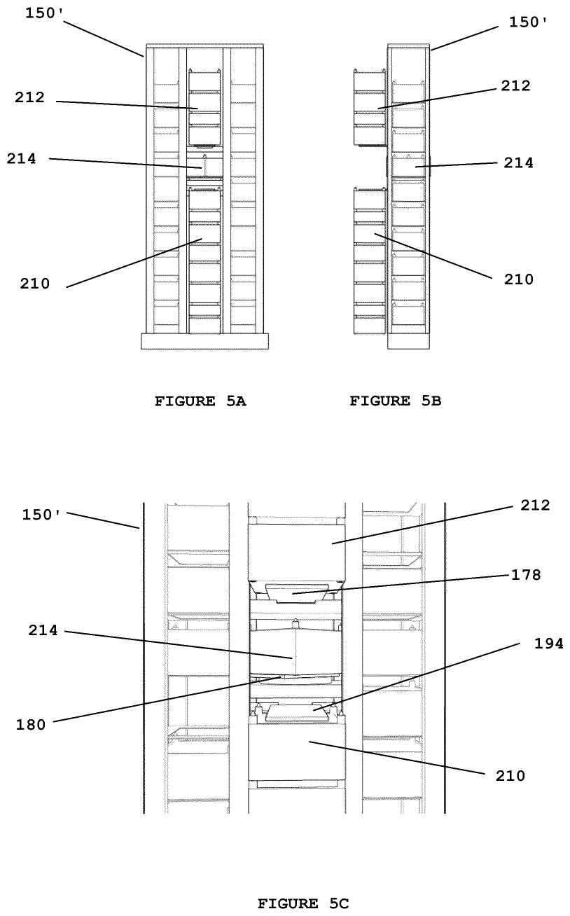

Referring now to FIG. 4 there is shown an isometric view of an exemplary mobile robot 150′ interfacing with an exemplary stack of totes, in accordance with some embodiments. Referring also to FIGS. 5A-C there are shown front, side and perspective views respectively of an exemplary mobile robot 150′ interfacing with an exemplary stack of totes, in accordance with some embodiments. The stack of totes is shown unsupported for clarity however as will be shown later the stack of totes may be supported by the floor or by some other supporting structure. The stack of totes is shown as having 3 portions. The 1^{st} portion 210 would be supported by the floor and at the upper end of it stabilized by paddle 194. The stack is further shown with a target tote 214 having been picked by paddle 180 and being rotated for placement into a storage shelf on bot 150′. The 3^{rd} portion 212 of the stack of totes is shown raised on paddle 178. In order to pick tote 214, upper portion of the stack 212 is lifted by paddle 178. Prior to or after the upper portion of the stack to 212 being raised by paddle 178, the lower paddle 194 may extend and bear down the lower portion of the stack 210 to stabilize the stack and retain the positional relationship between upper stack 212 and lower stack 210. After the upper portion of the stack 212 is raised by paddle 178, paddle 180 may extend into the stack to pick tote 214 with paddle 180. Once tote 214 has been picked, the upper stack 212 may be lowered onto the lower stack 210 and paddle 178 and/or paddle 194 withdrawn. At this point bot 150′ is free to move about the facility having removed tote 214 from the stack for transport to a workstation or otherwise. As shown bot 150 has multiple shelves where multiple totes can be picked and/or placed to and from the shelves and transported to a given destination.

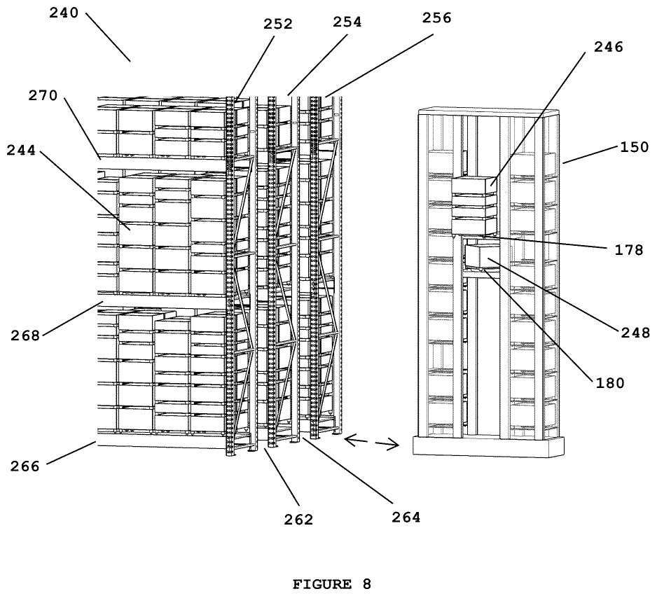

Referring now to FIG. 8 there is shown an exemplary tote transport robot 150 and exemplary storage rack 240 having exemplary stacks totes 244 stored therein, in accordance with some embodiments. Tote transport robot 150 is shown having a stack of totes 246 on paddle 178 and tote 248 on paddle 180 while in operation on a facility floor where in normal operation paddle 178 may not be extended with totes on paddle 178. Storage racks 240 is shown having 3 separate racks 252, 254, 256 with 2 aisles 262, 264 separating the racks. Stacks of totes are provided on 3 separate levels 266, 268, 270 where tote transport robot may selectively enter any aisle and pick or place any tote from any tote location within any stack within any level of rack 240.

Workstations may be provided, for example, there can be two typed of workstations. Dynamic where totes stay on bot as they are needed at the workstation for a very short time; e.g. presenting a product tote to pick from. Static where totes are offloaded from the bot, e.g. onto a conveyor where they remain resident for a longer operation. These operations might include: replenishment where cases are open and multiple eaches are loaded into the tote, order totes where many product tote presentations are required to present the eaches loaded into the tote, or customer dispense where the tote is needed outside the system to present to a customer.

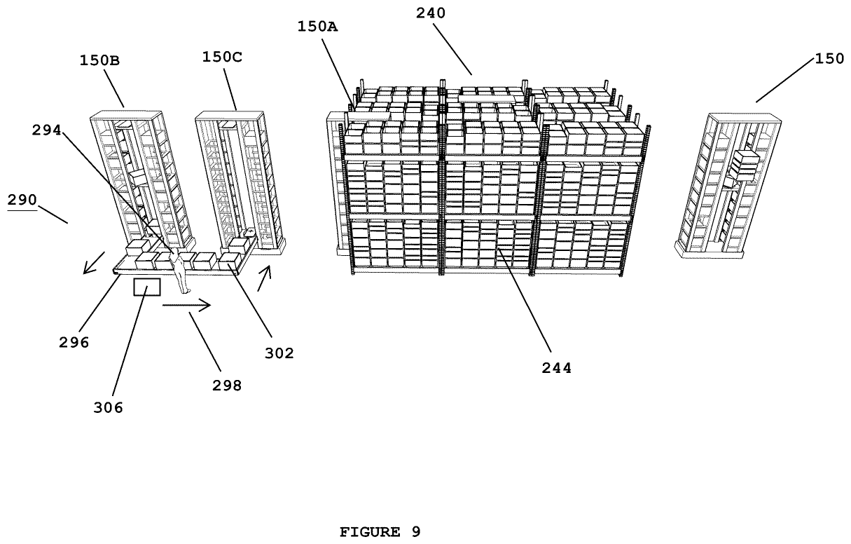

Referring now to FIG. 9 there is shown a perspective view of an exemplary tote transport robot 150, exemplary storage rack 240 having stacks of exemplary totes 244 stored therein and an exemplary workstation 290, in accordance with some embodiments. Tote transport robot 150 is shown outside of storage structure 240 where tote transport robot 150A is shown accessing totes within storage structure 240. In the exemplary embodiment shown, a picker 294 is shown standing in front of conveyor 296 where totes 302 are shown flowing 298 from robot 150B to robot 150C. In alternate aspects, robot 150C may not be provided, for example, where conveyor 296 may be configured to flow totes back to robot 150B in a loop or otherwise. Robots 150B and 150C utilize the tote handler(s) to place totes on conveyor 296 or pick totes from conveyor 296 where the totes may have been transported from storage or are being transported to storage via robots 150A and 150B. The totes may be product totes where product totes flow by picker 294 and where picker 294 picks product from the product totes and places them in an order tote or otherwise at location 306. Similarly, the totes may be order totes where order totes are consolidated for storage or otherwise. Similarly, the totes may be for replenishment, order dispense or otherwise.

In the picking workstation 290 shown, one mobile robot 150B unloads the product totes to be picked while another 150C initially empty mobile robot loads the product totes to subsequently return to the tote storage area. This is done to speed the presentation of totes at the picking workstation 290 verses having one mobile robot unload and reload the product totes, for example, resulting in approximately ½ the product tote presentation rate. Once the initially empty mobile robot 150C is fully loaded, it goes through the storage area to swap the old product totes with new product totes for the next order. The initially loaded mobile robot 150B now advances to the loading side of the workstation to receive totes from the subsequent mobile robot.

The same workstation 290, or similar layouts may alternately be used for: decanting cases and loading product totes with incoming eaches, picking orders as described above, presenting and storing order totes in the same storage area or a dedicated order storage area, and dispensing order totes to store employees for customer delivery or directly to customers. The mobile robots 150A and/or 150B may also be used as buffered sequence towers for buffering order totes for order consolidation and/or dispensing.

Other workstation configurations may alternately be provided, for example a workstation configuration may also interface the mobile robots. For example, a 6-axis robot may pick the totes from the mobile robots and place onto racks that subsequently go onto trucks. Example racks and rack interfaces may be found in US Patent Publication No. US 2022/0219904 A1 published Jul. 14, 2022 entitled “Transport Rack and Transport Rack Docking Interface” hereby incorporated by reference in its entirety.

In the case of 600 mm L×600 mm W format totes, the width of the aisles between the totes may be 900 mm to permit rotation of the tote while in the z-axis with approximately 25 mm per side clearance. The 900 mm aisle width may also provide sufficient width (greater than 600 mm) human access. The z-axis structure of the bot and structure that supports the storage shelves of the bot are afforded 100 mm per side of the 600 mm totes thereby resulting in an overall mobile robot width of approximately 850 mm, the same dimension of a 45 degree rotated tote, and allowing 25 mm clearance per side while traveling between the stored, stacked totes. Note: the 400 mm L×400 mm W totes would result in a 615 mm aisle width (assuming the same 25 mm clearance per side for rotated tote) which is just greater than the 600 mm required for human access making it potentially preferred for overall storage density. Totes may be directly stacked and supported by a floor or alternatively to direct stacking all the totes, expected to be approximately 6 m maximum, a conventional pallet rack structure as seen in structure 240 may be installed with levels spaced at approximately 2 m vertically. This approach reduces the stack heights to improve stability and reduces the maximum number of stacked totes required to be lifted when accessing any tote to be loaded or unloaded.

To protect humans performing maintenance within the stacked only storage configuration, a caged maintenance cart may be provided that drives between guardrails as the mobile robots do also (in one embodiment as will be described) and protects humans from the possibility of a falling tote while in the storage area. During normal operation, the entire storage area and all mobile robots may be within a caged, safety interlocked enclosure not accessible to humans for example, as disclosed in US Patent Publication No. US 2019/0176323 A1 published Jun. 13, 2019 and entitled “Configurable Service Isolation Zones for Service of Equipment Employing Mobile Robots” hereby incorporated by reference in its entirety. The mobile robots may receive a safety rated heartbeats to operate. If an e-stop is pressed on the system, or human access within the storage area is required, the heartbeat is stopped thereby disabling the motors of the mobile robots.

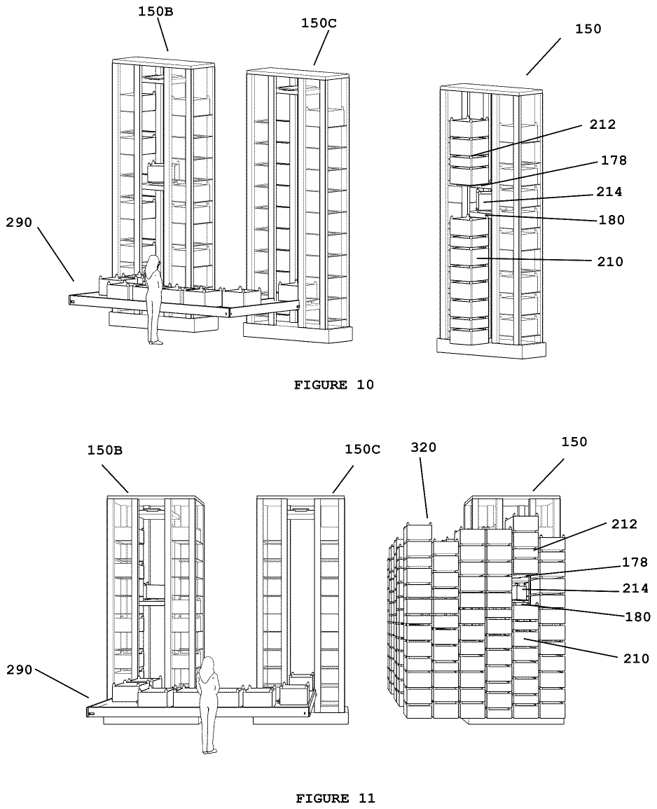

Referring now to FIG. 10, there is shown an isometric view of an exemplary workstation 290 with exemplary robots 150B, 150C interfacing to the workstation 290, in accordance with some embodiments. Robot 150 is shown interfacing with a stack of totes for clarity. Referring also to FIG. 11, the exemplary stack referred to in FIG. 10 is shown as part of an exemplary storage section 320 where storage section 320 has multiple exemplary stacks of totes, in accordance with some embodiments. Robots 150 may access the stacks to pick and place individual or stacks of totes therein. The stacks of totes are shown unsupported for clarity however as will be shown later the stack of totes may be supported by the floor or by some supporting structure. The stack of totes is shown as having 3 portions. The 1st portion 210 would be supported by the floor. The stack is further shown with a target tote 214 having been picked by paddle 180 and being rotated for placement into a storage shelf on bot 150. The 3rd portion 212 of the stack of totes is shown raised on paddle 178. In order to pick tote 214, upper portion of the stack 212 is lifted by paddle 178. After the upper portion of the stack 212 is raised by paddle 178, paddle 180 may extend into the stack to pick tote 214 with paddle 180. Once tote 214 has been picked, the upper stack 212 may be lowered onto the lower stack 210 and paddle 178 withdrawn. At this point bot 150 is free to move about the facility having removed tote 214 from the stack for transport to a workstation or otherwise. As shown bot 150 has multiple shelves where multiple totes can be picked and/or placed to and from the shelves and transported to a given destination.

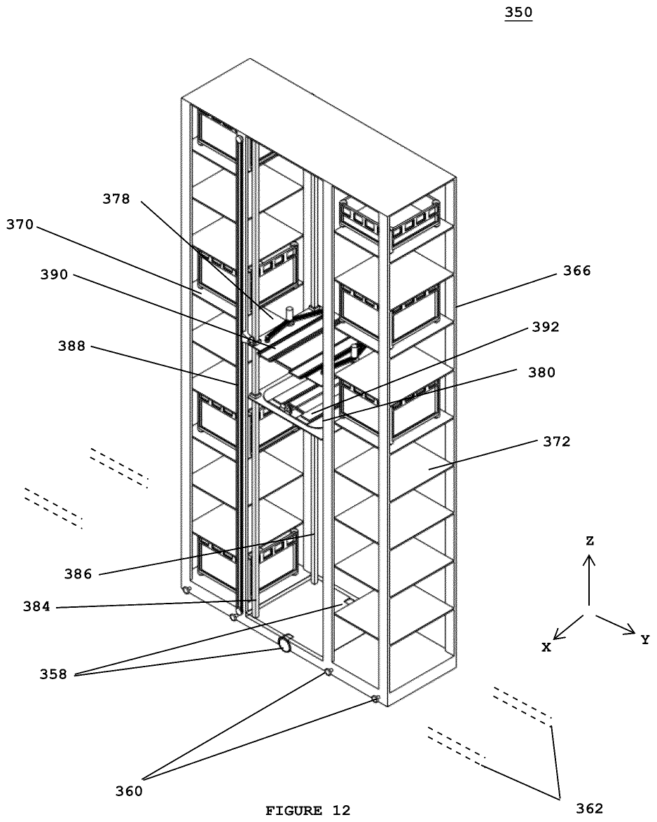

Referring now to FIG. 12, there is shown an isometric view of an exemplary tote transport robot 350, in accordance with some embodiments. Tote transport robot 350 may have features as described with respect to transport robots 150 and 150′ as well as features described herein. Mobile robot 350 has base 356 where base 356 may have features of an AMR (autonomous mobile robot). AMR base 356 may have driving wheels 358 where driving wheels 258 may be independently driven to allow AMR base 356 to move autonomously about a surface. Casters or other wheels (not shown) may also be provided interfacing with the same surface as driving wheels 358 for stability of the AMR base 356. Mobile robot 350 may further have counterwheels 360 on opposing sides of AMR base 356 that are constrained to operate within tracks 362 such that as moment loads are applied to mobile robot 350, for example, from picking a stack of totes the mobile robot 350 will not tip over and instead the moment load is reacted by a combination of the counterwheels that operate within tracks 362. Similar to mobile robot 150, mobile robot 350 may travel down aisles of the storage structure and selectively pick and place containers for totes for transport from the stored structure to workstations and back. Mobile robot 350 further has frame 366 with opposing storage shelves 370, 372 where opposing storage shelves 370, 372 are provided within frame 366 to store and buffer totes. Mobile robot 350 further has 2 tote handling devices 378, 380. Each tote handling device 378, 380 is independently removable in the +/−Z direction where tote handling devices 378, 380 are coupled to frame 366 by guide rails 384, 386. Independently operable Z drives 388 may be provided for each tote handling device 378, 380 to be independently removable in the +/−Z direction where the Z drives may be a lead screw driven, belt driven or driven by any suitable positioning mechanism. Handling device 378 has lift platform forks 390 that are movable in a plus or minus x-direction where forks 390 are configured to raise or lift one or more totes as will be described in greater detail. Paddle 390 is coupled to a chassis of tote handling device 378 by rails or guides or any suitable constraining device such that paddle 390 is movable in a plus or minus x-direction. The rails or guides may be telescoping and paddle 390 may be driven by a suitable belt drive lead screw drive or other suitable mechanism to selectively position paddle 390 in a plus or minus x-direction. In alternate aspects, handling device 378 may have additional axis′, for example, a rotary axis that allows paddle 390 to also pick from and place to shelves 370, 372. Similarly, handling device 380 has paddle or cargo platform forks 392 that is movable in a plus or minus x-direction but also rotationally about the Z axis where forks 392 are configured to raise or lift one or more totes as will be described in greater detail. Forks 392 is coupled to rotational drive which is then coupled to a chassis of tote handling device 380. Paddle 392 is coupled to a rotational drive by rails or guides or any suitable constraining device such that paddle 392 is movable in a plus or minus x-direction when the rotational drive is positioned to point forks 392 in an X direction (as seen in FIG. 12). The rails or guides may be telescoping and forks 392 may be driven by a suitable belt drive lead screw drive or other suitable mechanism to selectively position forks 392 in a radial direction with respect to the rotational drive. The rotational drive may be coupled to a chassis of tote handling device 380 by suitable bearing(s) and may have be servo or stepper driven by any suitable rotational drive that allows forks 392 to be rotated about the Z axis. While tote handling device 378 is configured to lift a stack of totes, tote handling device 380 is configured to pick or place one or more totes from a stack of totes and pick or place the one or more totes from or to shelves 370, 372 for transport to or from a workstation. An exemplary picking operation of an exemplary mobile robot 350 will now be described sequentially referring to FIGS. 13-26, in accordance with some embodiments.

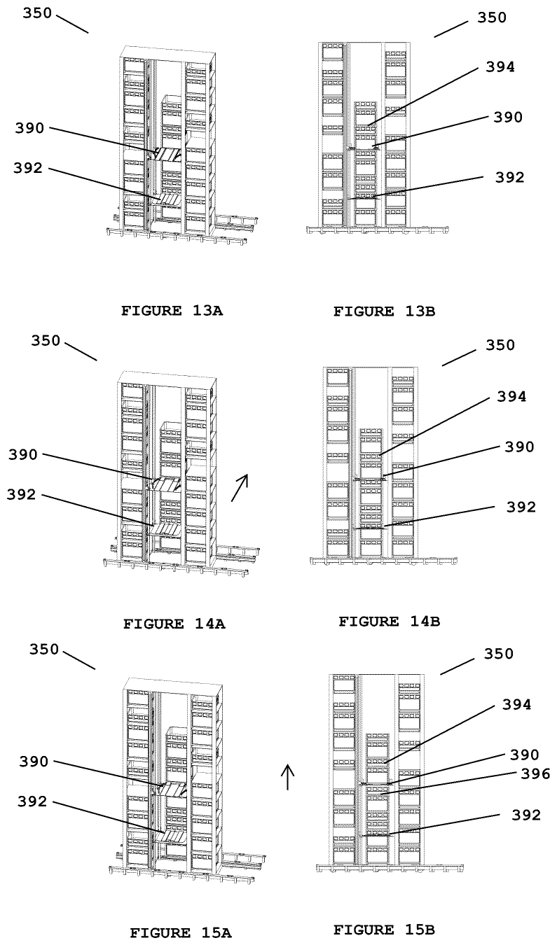

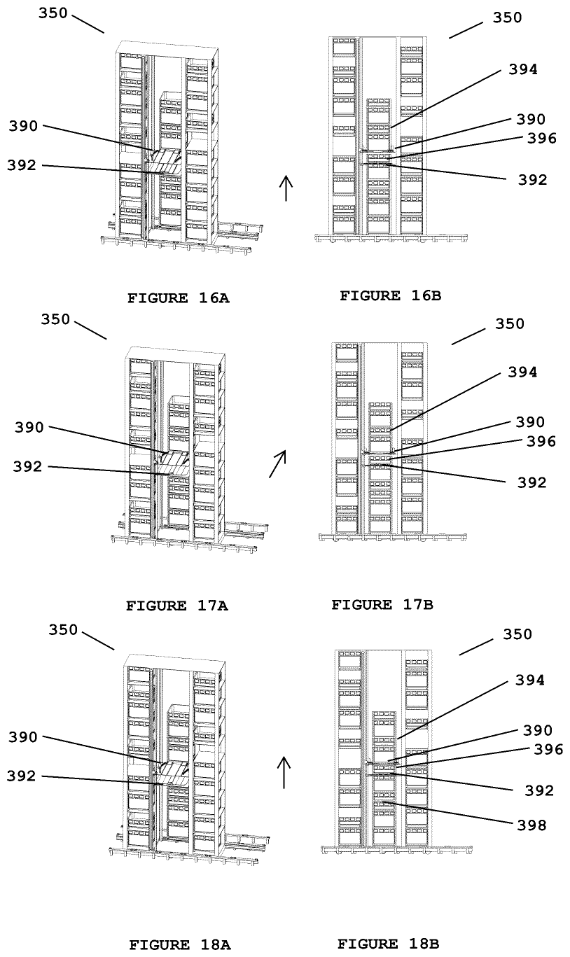

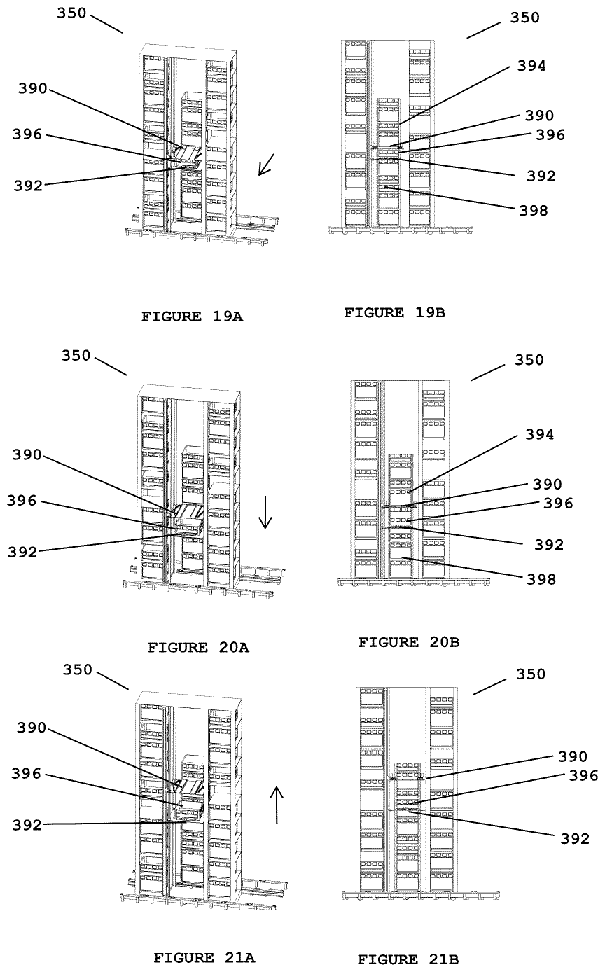

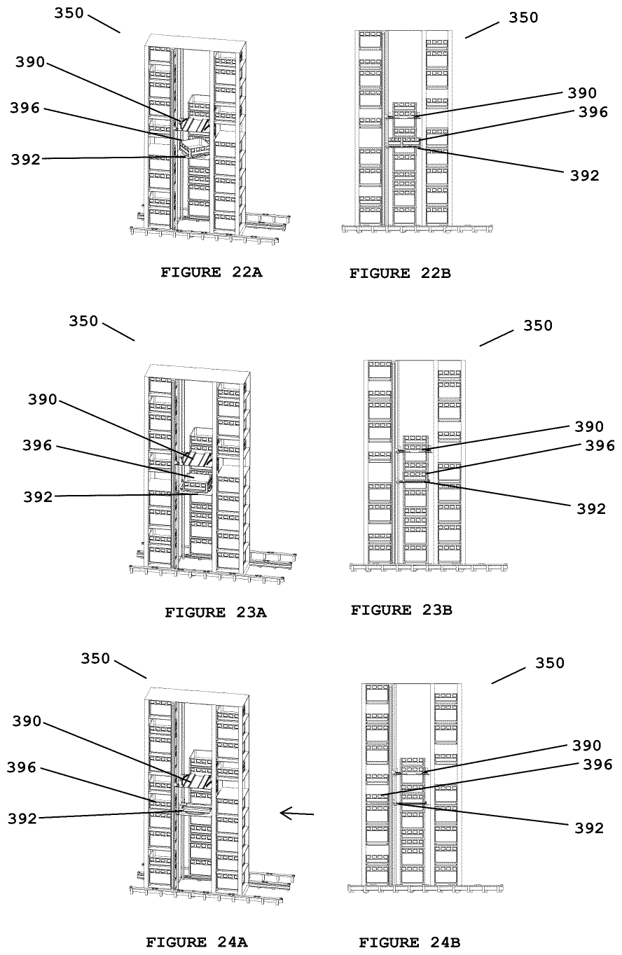

Referring now to FIGS. 13A-13B, there are shown perspective and side views of mobile robot 350 located in a position for forks 390 in position to pick a stack of totes 394, in accordance with some embodiments. Referring now to FIGS. 14A-14B, there are shown perspective and side views of mobile robot 350 located in a position for lift platform forks 390 to engage with tote stack 394, in accordance with some embodiments. Referring now to FIGS. 15A-15B, there are shown perspective and side views of mobile robot 350 located in a position for lift platform forks 390 to lift tote stack 394 to the point where lift platform 390 raises the tote stack 394 sufficiently to clear any tote locating feature or other wise that would prevent subsequent picking of target tote 396, in accordance with some embodiments. Referring now to FIGS. 16A-16B, there are shown perspective and side views of mobile robot 350 located in a position where cargo platform raises to be in a position to pick a desired or target tote 396, in accordance with some embodiments. Referring now to FIGS. 17A-17B, there are shown perspective and side views of mobile robot 350 located in a position where cargo platform forks 392 engage underneath desired tote 396 to be able to lift tote 396, in accordance with some embodiments. Referring now to FIGS. 18A-18B, there are shown perspective and side views of mobile robot 350 located in a position where cargo platform 396 raises to clear tote locating feature on lower stack 398 where target tote 396 is now supported by forks 392 and ready to be extracted from the stack without interference of either of stacks 394, 398, in accordance with some embodiments. Referring now to FIGS. 19A-19B, there are shown perspective and side views of mobile robot 350 located in a position where the cargo platform forks 392 are returned or retracted, carrying the desired tote 396 into the bot 350, in accordance with some embodiments. Here, upper and lower stacks 394, 398 are aligned in the z direction with an open space where the just removed tote 396 was previously. Referring now to FIGS. 20A-20B, there are shown perspective and side views of mobile robot 350 located in a position where lift platform 390 lowers the upper stack of totes 394 back into the storage system such that the upper stack of totes 394 is placed upon and supported by the lower stack of totes 398, in accordance with some embodiments. Here, the forks 392 are then withdrawn from beneath the upper stack of totes 394. Note that the cargo platform forks 392 along with the payload target tote 396 are also lowered to avoid interference between tote handlers 390, 392. Referring now to FIGS. 21A-21B, there are shown perspective and side views of mobile robot 350 located in a position where cargo platform 392 raises to desired storage location, while lift platform 390 raises for clearance, in accordance with some embodiments. Referring now to FIGS. 22A-22B, there are shown perspective and side views of mobile robot 350 located in a position where cargo platform 392 rotates with target tote 396 to begin storing the target tote, in accordance with some embodiments. Referring now to FIGS. 23A-23B, there are shown perspective and side views of mobile robot 350 located in a position where cargo platform 392 with target tote 396 has rotation complete and target tote 396 is ready to deposit into storage on a shelf of mobile robot 350, in accordance with some embodiments. Referring now to FIGS. 24A-24B, there are shown perspective and side views of mobile robot 350 located in a position where cargo platform forks extend 392, such that the target tote 396 is extended to subsequently be placed on the shelf of mobile robot 350 over the storage platform (shelf), in accordance with some embodiments. Referring now to FIGS. 25A-25B, there are shown perspective and side views of mobile robot 350 located in a position where cargo platform forks 392 lower tote 396 from forks 392 to storage platform, such that the target tote 396 is placed on the shelf or storage platform of mobile robot 350, in accordance with some embodiments. Referring now to FIGS. 26A-6B, there are shown perspective and side views of mobile robot 350 located in a position where cargo platform forks retract completing the placement of tote 396 and leaving the tote 396 in the bot's storage shelf, in accordance with some embodiments. The exemplary sequence may be reversed to transport a tote from a storage shelf on mobile robot 350 to a stack of totes.

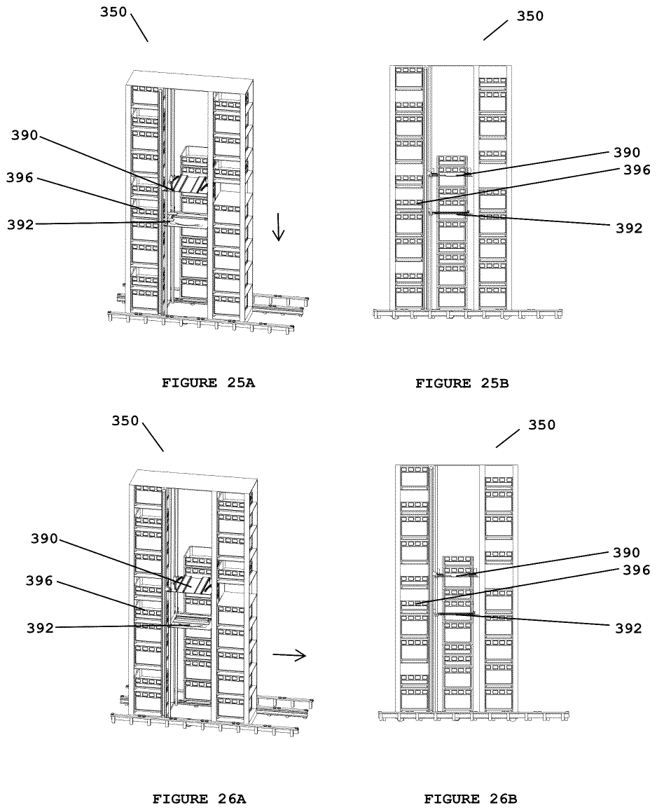

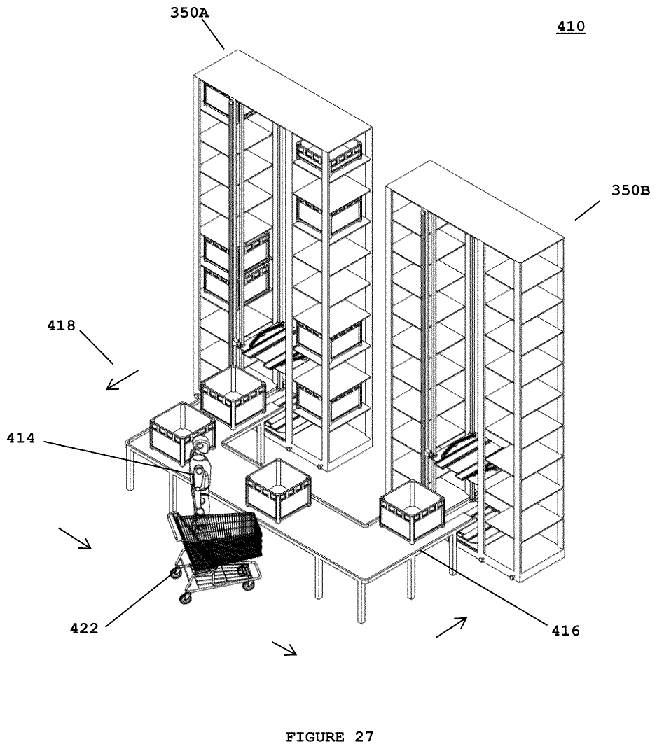

Referring now to FIG. 27 there is shown a perspective view of workstation 410. In the exemplary embodiment shown, a picker 414 is shown standing in front of conveyor 416 where totes 302 are shown flowing 418 from robot 350A to robot 350B, in accordance with some embodiments. In alternate aspects, robot 450B may not be provided, for example, where conveyor 416 may be configured to flow totes back to robot 350A in a loop or otherwise. Robots 350A and 350B utilize the tote handler(s) to place totes on conveyor 416 or pick totes from conveyor 416 where the totes may have been transported from storage or are being transported to storage via robots 350A and 350B. The totes may be product totes where product totes flow by picker 414 and where picker 414 picks product from the product totes and places them in a cart 422 where cart 422 may also have bags or containers to hold the eaches that are picked making up an order in cart 422 (not shown). Similarly, the totes may be order totes where order totes are consolidated for storage or otherwise. Similarly, the totes may be for replenishment, order dispense or otherwise. In the embodiment shown, bot 350A on the left may arrive with each tote needed to fulfill an order. Bot 350A then unloads them into a conveyer loop 416 past an associate 414 who compiles the customer order into a shopping cart 422. The totes then return into an empty bot 350B to be brought back into the storage portion of the system. The now empty bot on the left 350A would then move to the right position for restocking where another mobile robot would arrive with the next grouping of product totes to make up the next order.

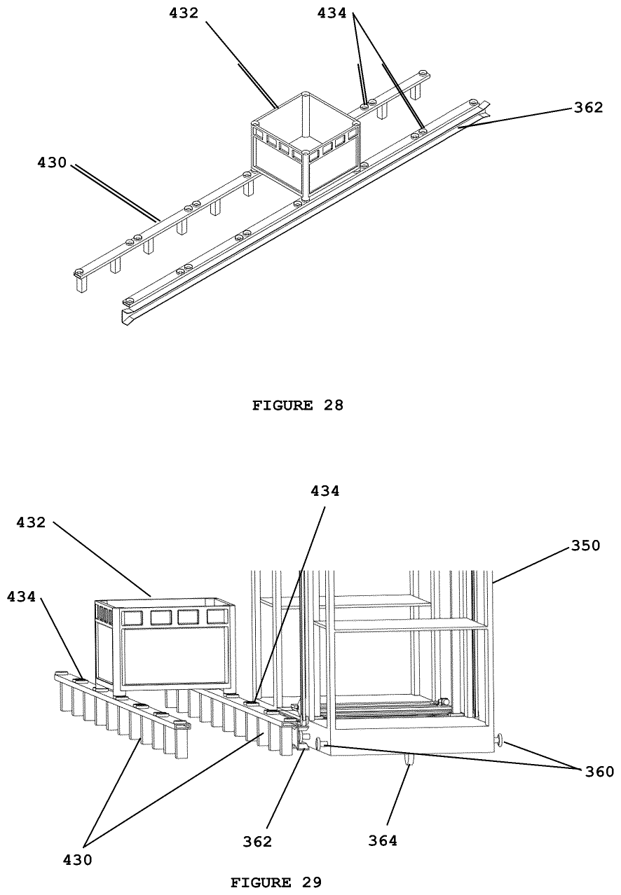

Referring now to FIG. 28 there is shown a perspective view of tote supporting floor structure 430 and tote 432 engagement to tote supporting floor structure 430, in accordance with some embodiments. Two tote supporting rails feature cups 434 that the feet on the totes 432 sit in, insuring proper location. The right most rail may also host bot track 362, a necked entrance-C channel member used to secure the bot and resolve the adverse moment caused when lifting. Referring also to FIG. 29 there is shown the guide wheels 360 on the side of the bot 350 entering the C channel track 362. Although a C-channel is shown on the left side of bot 350, an additional channel (not shown) may similarly be provided on the right side of bot 350, in accordance with some embodiments. Further casters 364 (one end shown) referred to above with respect to FIG. 12 are shown.

As will be described, Totes have stand-offs with lead ins to enable secure stacking. The stand-offs also provide space between the stacked totes for two purposes: provide space to insert stack-lifting or tote-transferring end-effector, and allow airflow to reach stored items (especially chilled and frozen). Totes may be 600 mm L×600 mm W×various heights (100 mm, 200 mm, 300 mm, 400mm) or any suitable size, for example, alternatively may be 400 mm L×400 mm W (downside is aisle is not wide enough for humans). Totes may use dividers, for example, of subtotes. Totes may be arranged in stacks and arranged leaving aisles for Mobile robots to pass through. Totes may be omitted every 8 totes or so along aisle as fire break according to local jurisdiction requirements. First totes in a stack may be placed on mechanical bases with pins or sockets that are adjustable in z to level to the floor and provide a solid foundation for the tote stack. The bases may be integral with the mobile robot guardrail, that also provides constraint for the anti-tip counterwheels of the mobile robots. Totes may be direct stacked in storage for space efficiency but stored on shelves within the mobile robots for speed of access and random access when unloading at the picking workstation conveyor. In this way, the mobile robot serves as a Buffer Sequence Tower for the picking workstation to ensure product totes are presented on the desired picking sequence (for bagging or placing directly into order totes). Totes may be composite in construction and may have gussets provided for stability of rail and also to prevent the tote from tipping; it reacts the moment imparted by the weight of the bot on the rails or on the climbing channels.

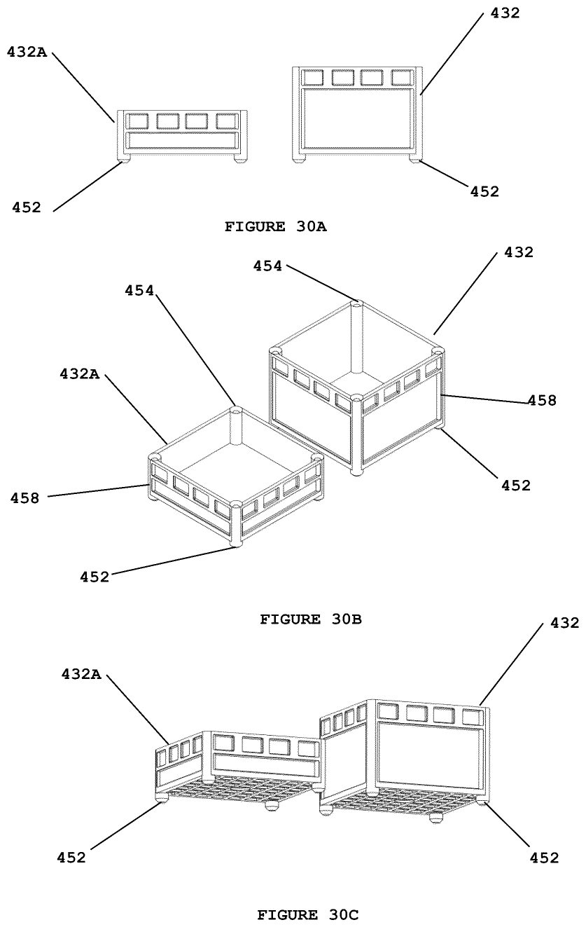

Referring now to FIGS. 30A-30C there are shown side, upper perspective and lower perspective views respectively of totes 432, 432A, in accordance with some embodiments. Totes 432 and 432A are shown varied in size in order to increase volumetric storage efficiency of the system. Chamfered or cupped feet 542 on the bottom of the totes and mating features 454 such as cups are shown on each corner for positioning and stacking. In the embodiment shown, 4 feet and cup sets are shown for each tote; in alternate aspects more or less may be provided. When the totes are stacked on each other, there is sufficient clearance under each tote such that stacks of one or more totes may be lifted and target totes picked and placed. In the embodiment shown, 4 posts 458 are provided between cupped feet 542 on the bottom of the totes and mating features 454 on the top. Posts 458 direct the load associated stacked totes through the post(s) and to the floor such that the posts 458 are supporting the load associated with stacks of totes above a given tote. The totes may be made of any suitable material such as fire-retardant polypropylene or any suitable material or combination of materials.

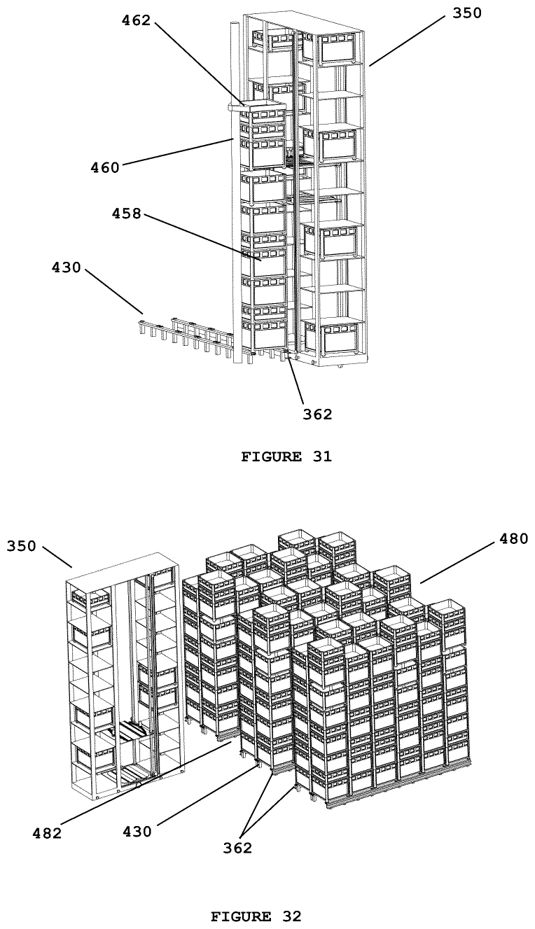

Referring now to FIG. 31 there is shown mobile robot 350 picking a stack of totes as well as a target tote from stack of totes 458 that are supported on tote supporting floor structure 430, in accordance with some embodiments. In the embodiment shown, a sliding plate 462 is placed on top of the tote stack 458 and fixed to a pole 460 such that as the bot lifts one or more totes, the plate 462 keeps the stack 468 aligned. Further, the addition of sliding plate 462 allows post 460 to react some of the load of the picked stack such that guides 362 are relieved of reacting the moment to an extent.

Referring now to FIG. 32 there is shown mobile robot 350 interfacing with tote storage 480, in accordance with some embodiments. Tote storage 480 is shown having 3 rows of stacked totes 6 totes long and 2 totes deep where the stacks of totes are supported by tote supporting and positioning structure 430. The rows are separated by aisles 482 where guide rails 362 are on opposing sides of aisles 482. Mobile robot 350 may enter into the storage structure 480 via aisles 482 to selectively pick and/or place totes within storage structure 480.

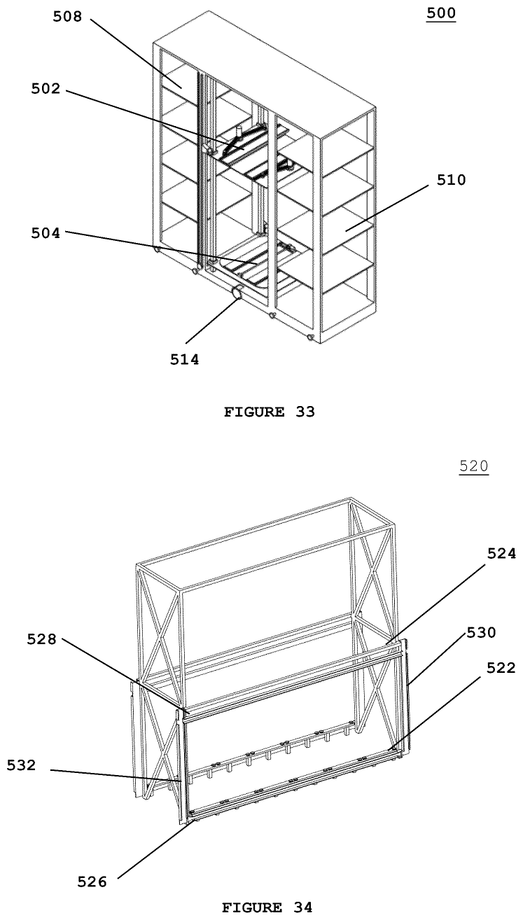

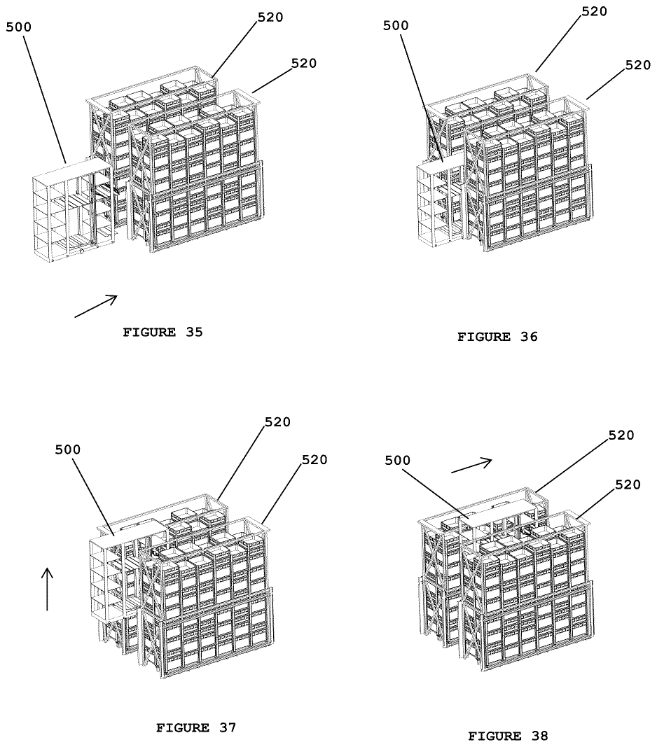

Referring now to FIG. 33, there is shown an isometric view of mobile robot 500, in accordance with some embodiments. Mobile robot 500 has features similar to mobile robots 350, 150 or 150′ but with the ability to climb and move within a storage structure as will be described. Mobile robot 500 is shown having upper and lower tote transfer arms 502, 504 with 5 shelves each 508, 510 for tote storage. Mobile robot 500 further has traction drives 514 however the traction drives are equipped with climbing pinions and counterwheels as disclosed in US Patent Publication No. US2020/0087067 Al published on Mar. 19, 2020 and entitled “Climbing Robot with Compliant Pinion Drive” hereby incorporated by reference in its entirety. Referring also to FIG. 34, there is shown an isometric view of tote storage structure 520, in accordance with some embodiments. Tote storage structure 520 has shelves 522, 524 arranged to support totes thereon. Tote storage structure 520 further has horizontal rails 526, 528 that in combination with an opposing rack support the mobile robot 500 at different elevations within the storage structure as will be shown. Tote storage structure 520 further has vertical climbing rails that cooperate with climbing pinions and counterwheels of traction drives 514 of mobile robot 500 such that mobile robot 500 can climb, for example from rail 526 to rail 528 and access totes on multiple tote storage shelf levels. As seen in FIG. 35, two opposing storage structures 520 form an aisle therebetween for mobile robot 500 to enter utilizing the drive wheels of traction drives 514, in accordance with some embodiments. In FIG. 36, mobile robot 500 utilizes the pinions and counterwheels of traction drives 514 to engage rails 532, in accordance with some embodiments. In FIG. 37, mobile robot 500 utilizes the pinions and counterwheels of traction drives 514 to climb rails 532, in accordance with some embodiments. In FIG. 38, mobile robot 500 utilizes the drive wheels of traction drives 514 to horizontally move to a target tote on horizontal rails 528, in accordance with some embodiments.

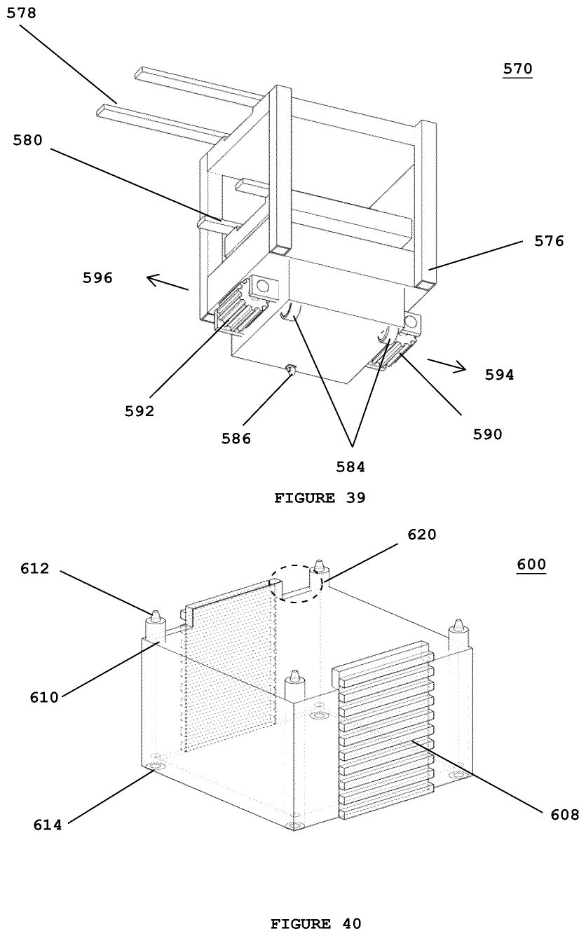

Referring now to FIG. 39, there is shown a lower isometric view of mobile robot 570, in accordance with some embodiments. Mobile robot 570 may have tote handling features similar to Bot 150, 150′ and 350 however mobile robot 570 is disclosed as also being capable of climbing totes or stacks of totes where mobile robot 570 interfaces with mating features on the totes to be able to access target tote(s) in a given stack of totes. Mobile robot 570 has frame 576 with an upper tote handler 578 and lower tote handler 580 where the primary function of upper tote handler 578 is to raise a stack of totes that are positioned above a target tote and where the primary function of lower tote handler 580 is to pick and place target totes for transport to/from a workstation. Mobile robot 570 has a pair of independently driven wheels 584 that cooperate with caster 586 to allow mobile robot 570 to autonomously move about a surface or floor as the case may be. Two or more opposing gears or pinions 590, 592 are provided for climbing within a given structure. Referring also to FIG. 40, tote 600 is shown having climbing features, in accordance with some embodiments. The two or more opposing gears or pinions 590, 592 may be extended or retracted 596, 594 to mate (when extended) with rack features 608 formed as part of the tote 600, as shown on opposing sides of the tote 600. As previously described, tote 600 may also have posts 610 with mating features 612, 614 that facilitate accurate stacking of totes 600. Rack features 608 are shown such that if totes are stacked that the rack features of the adjoining totes mate to provide a continuous rack upon which to climb vertically. Further openings 620 are formed between the rack feature 608 and supporting post 610 to allow the forks from mobile robot 570 to enter for a pick or place of tote 600.

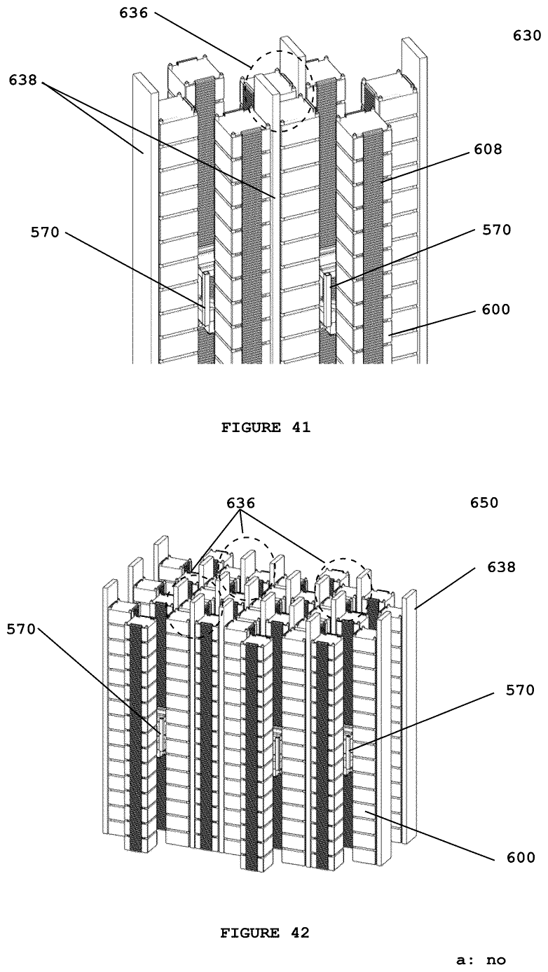

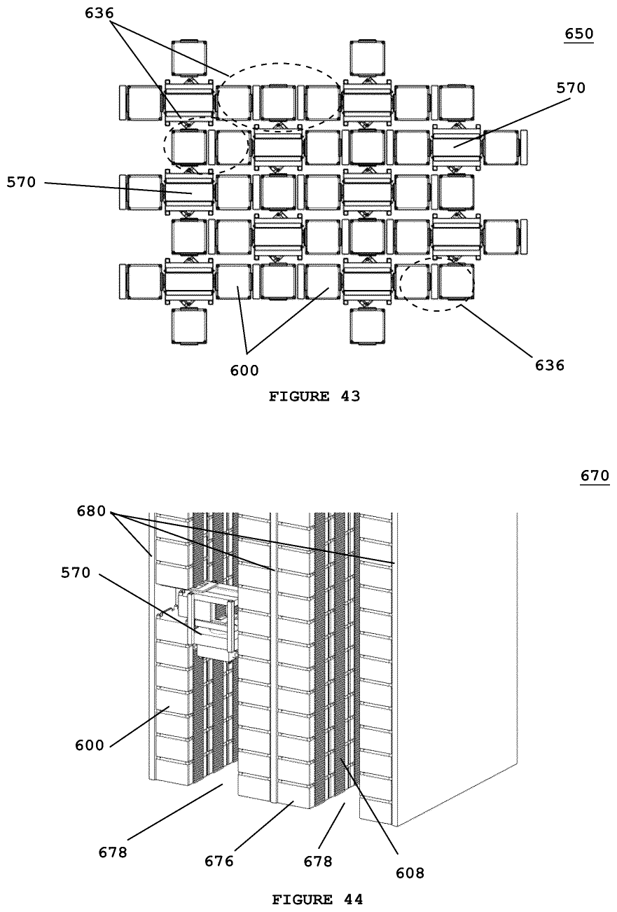

Referring now to FIG. 41, tote climbing bot 570 is shown climbing within tote storage structure 630, in accordance with some embodiments. Tote storage structure 630 has stacks of totes 600 where the rack portion 608 of each tote form a continuous rack the height of the stack of totes 600. Mobile robots 570 are shown climbing within groups of 4 totes facing inward with totes overlapping each other at 636 in order to minimize footprint. Upright structure walls 638 are shown to react any forces from the rack and pinion and to further provide support for seismic safety. Referring also to FIGS. 42 and 43 there is shown an isometric and top view respectively of tote storage structure 650 which has features similar to storage structure 630 except additional groups of 4 totes facing inward with totes overlapping each other at 636 in order to minimize footprint, in accordance with some embodiments. Mobile robots 570 may climb within structure 650 or alternately move about on the base or floor of structure 650 as will be described or alternately move about a top surface on structure 650 (not shown for clarity).

Referring now to FIG. 44, tote climbing bot 570 is shown climbing within tote storage structure 670, in accordance with some embodiments. Tote storage structure 670 has 1 and 2 deep rows 676 with stacks of totes 600 where the rack portion 608 of each tote form a continuous rack the height of the stack of totes 600. Mobile robots 570 are shown climbing within aisles between the rows of totes facing inward. Upright structure walls 680 are shown to react any forces from the rack and pinion and to further provide support for seismic safety.

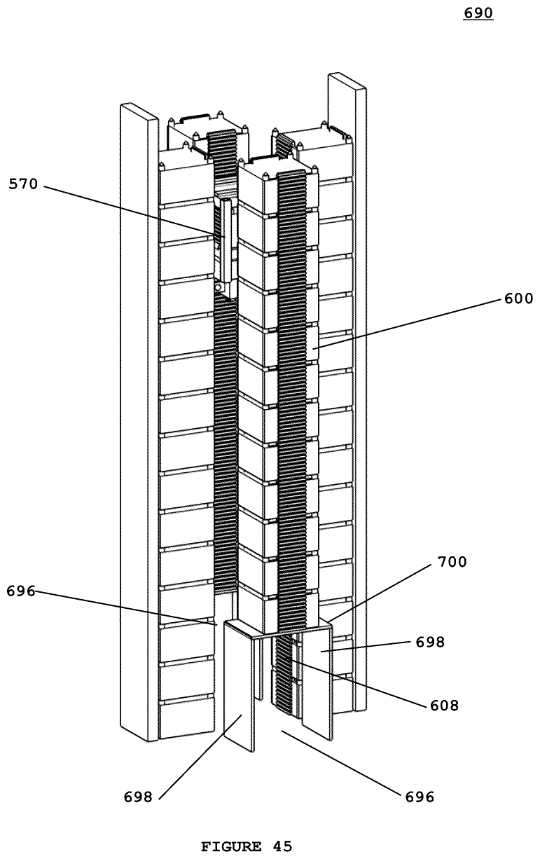

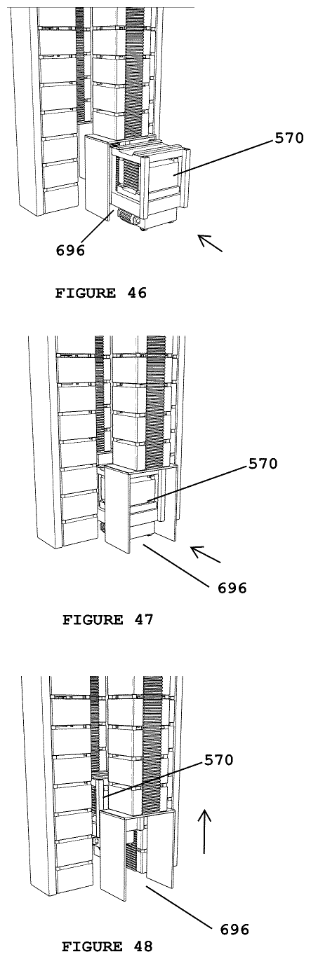

Referring now to FIG. 45, tote climbing bot 570 is shown climbing within tote storage structure 690, in accordance with some embodiments. Tote storage structure 690 may have features as disclosed with respect to FIGS. 39-43 with the addition of one or more mobile robot access points 696. Mobile robot access points 696 is shown having walls 698 and tote support 700. Walls 698 and tote support 700 together with the surface or floor that supports them form an opening through which climbing bot 570 can gain access to the totes within structure 690 where a tote stack may be provided on the tote support surface 700 giving tote climbing bot 570 access to any tote(s) within the cluster of totes. Referring also to FIG. 46, tote climbing bot 570 is shown entering mobile robot access point 696, in accordance with some embodiments. Referring also to FIG. 47, tote climbing bot 570 is shown passing through mobile robot access point 696, in accordance with some embodiments. Referring also to FIG. 48, tote climbing bot 570 is shown having passed through mobile robot access point 696 and further having extended its climbing pinions to interface with and climb on tote racks 608, in accordance with some embodiments.

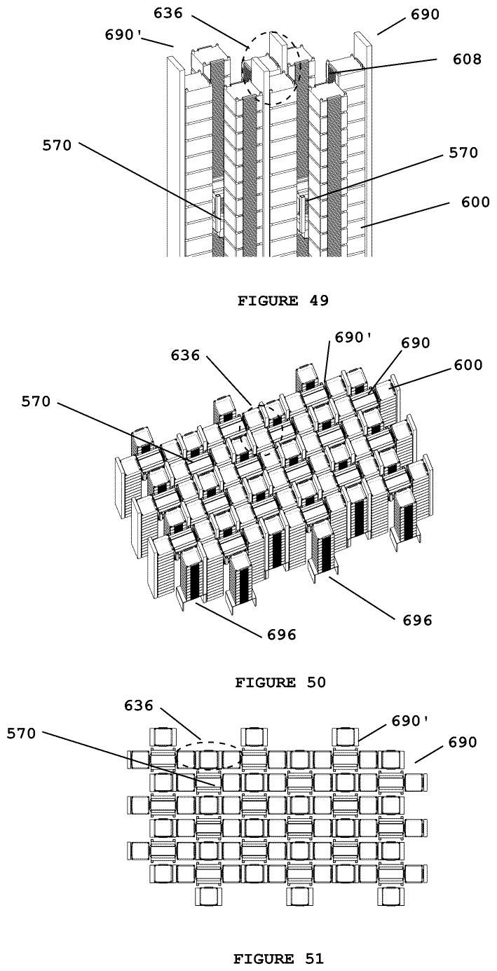

Referring now to FIG. 49 there is shown tote storage structure 690 coupled to a tote storage structure 690′, in accordance with some embodiments. Referring also to FIG. 50 there is shown an isometric view of multiple tote storage structures 690, 690′ etc., in accordance with some embodiments. Referring also to FIG. 51 there is shown a top view of multiple tote storage structures 690, 690′ etc., making up a tote storage structure, in accordance with some embodiments. Mobile robots 570 are shown climbing within stacks of totes 600 where the stacks of totes formally substantially continuous climbing rack 608. Mobile robots 570 can enter or leave the tote storage structure at any of a number of openings 696. Stacks of totes 600 can be positioned adjacent to each other, for example at positions 636 in order to reduce the footprint of the overall storage structure.

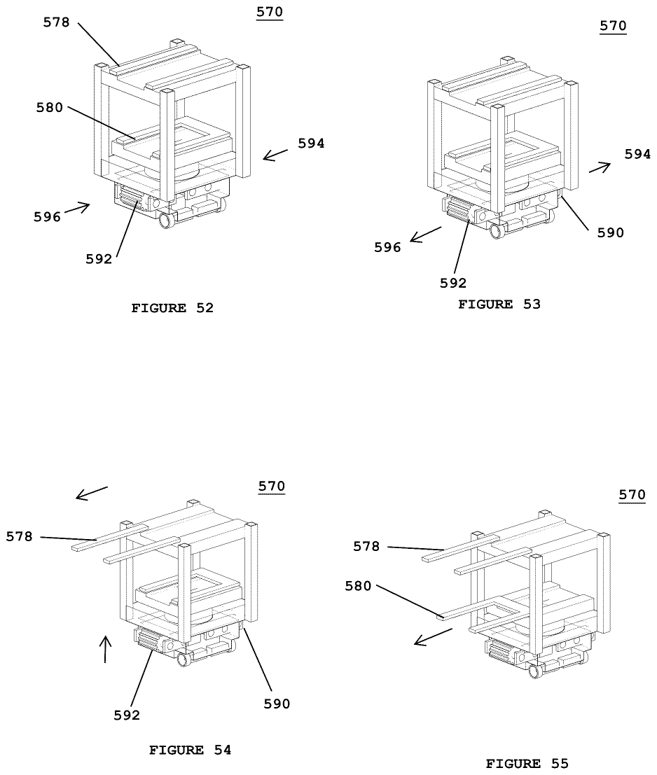

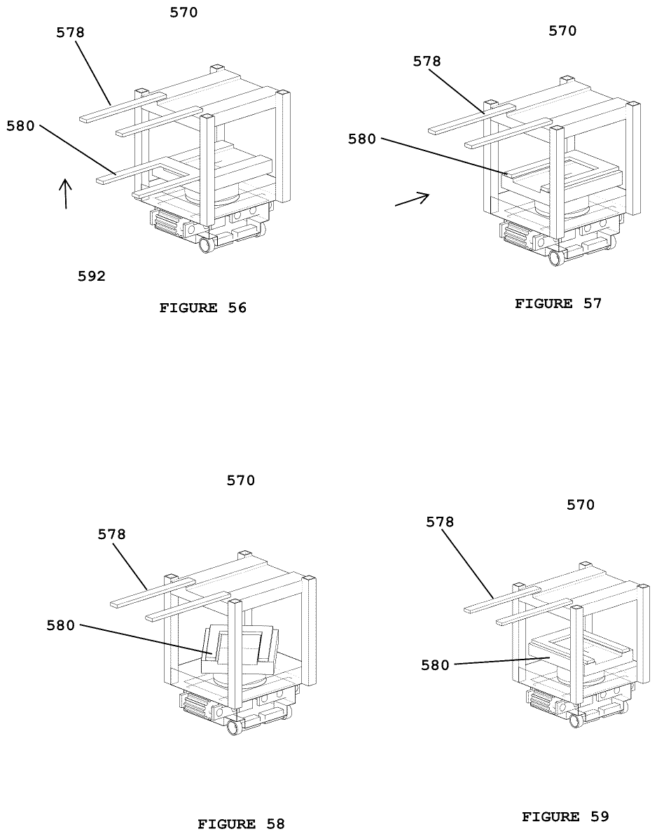

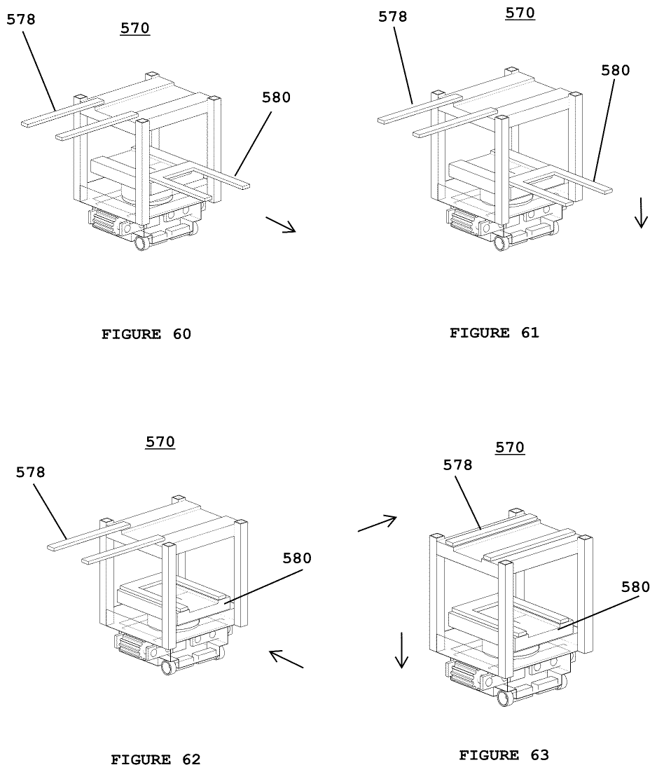

Referring now to FIGS. 52 through 63 there are shown isometric views of mobile robot 570 in differing states of operation, in accordance with some embodiments. In FIG. 52 mobile robot 570 is shown with pinions 590, 592 retracted 594, 596 with upper tote stack lift arm 578 and lower tote transfer of arm 580 also retracted, in accordance with some embodiments. In FIG. 53 the mobile robots 570 pinions 590, 592 extend 594, 596 to engage mating rack features in totes 600 (not shown), in accordance with some embodiments. In FIG. 54 mobile robot 570 is shown with upper lift arm 578 extending to engage beneath a stack of totes 600 (not shown) and lift the stack using pinions 590, 592, in accordance with some embodiments. In FIG. 55 the lower tote transfer arm 580 extends beneath a target tote (not shown), in accordance with some embodiments. In FIG. 56 the lower tote transfer arm 580 lifts the target tote (not shown), in accordance with some embodiments. In FIG. 57 the lower tote transfer arm 580 retracts with the target tote (not shown), in accordance with some embodiments. In FIG. 58 the lower tote transfer arm 580 rotates the target tote to the point where in FIG. 59 the target tote is 90° from where it was picked, in accordance with some embodiments. In FIG. 60 the target tote extended to a placement location (not shown) and the target tote lowered to the placement location as seen in FIG. 61, in accordance with some embodiments. The raising and lowering of the fork on tote transfer arm 580 may be by pinions 590, 592 or alternately may be by a separate vertical Z drive that is a portion of transfer arm 580. In FIG. 62 tote transfer arm 580 retracts, in accordance with some embodiments. In FIG. 63 tote stack lift arm 578 utilizes pinions 590, 592 to lower the stack of totes onto the stack of totes below it and stack lift arm 578 retracts, in accordance with some embodiments.

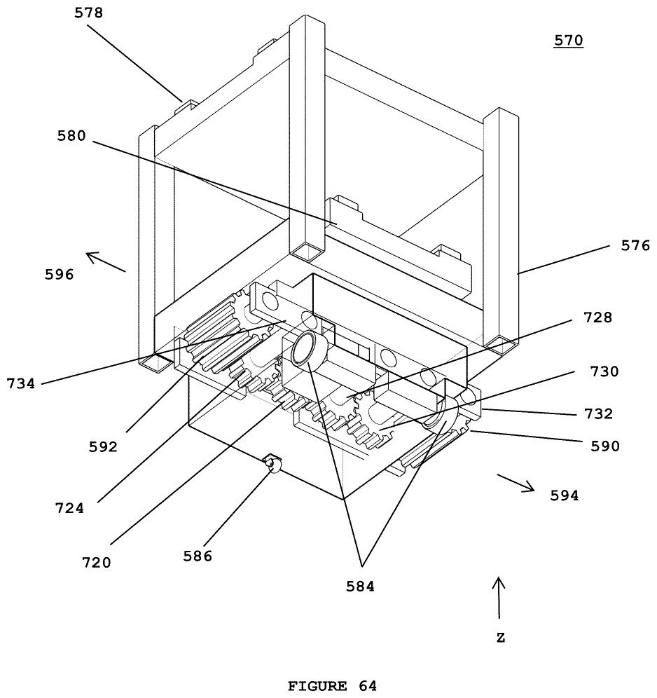

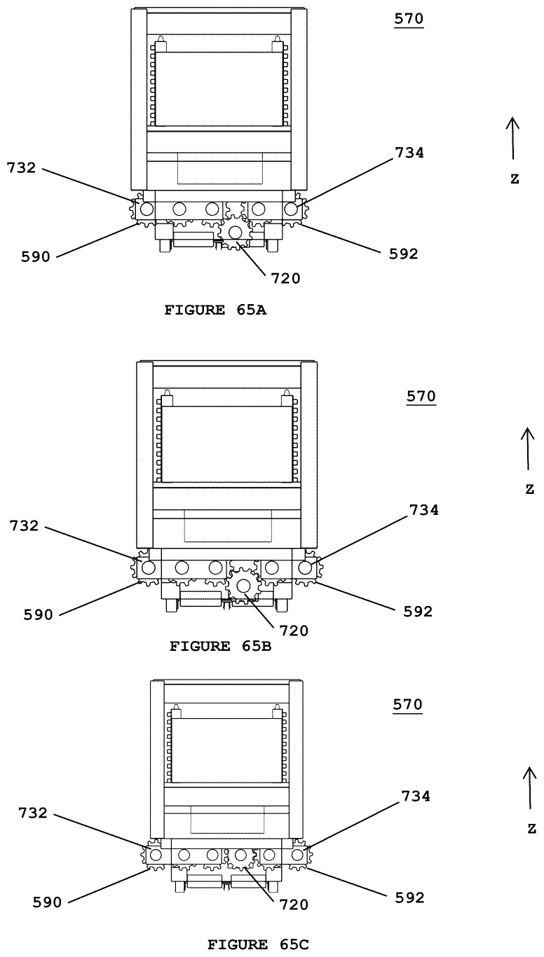

Referring now to FIG. 64 there is shown the bottom isometric view of mobile robot 570, in accordance with some embodiments. Mobile robot 570 has frame 576, upper tote transfer arm 578 and lower tote transfer arm 580. Upper tote transfer arm 578 may be configured to extend and retract a fork or paddle where the fork or paddle is constrained by slides or other suitable linear constraint. The fork or paddle of upper tote transfer arm 578 may be positioned using a belt drive, ball screw drive or any suitable linear drive utilizing conventional motion to control technology such as servo or stepping motor drives. Alternately the fork or paddle of upper tote transfer arm 578 may be an articulated arm or any suitable transfer mechanism. In alternate aspects upper tote transfer arm may have additional axes such as rotary or vertical Z axis. Where no Z axis as provided upper tote transfer arm 578 may move in Z utilizing pinions 590 and 592 to raise and lower the entire mobile robot 570. Lower tote transfer arm 580 may have features similar to upper tote transfer arm 578. In addition, lower tote transfer arm 580 may have a dedicated Z axis drive which may be a ball screw drive or other suitable Z axis drive that is driven by conventional motion control technology such as stopper or servo drives. Lower tote transfer arm 580 may further have a dedicated rotary axis for example about Z that may be directly driven belt driven or otherwise driven by conventional motion control technology such as stepper or servo drives. Mobile robot 570 may autonomously move around on a flat surface by utilizing independent opposing traction drives 584 where traction drives 584 may be directly driven servo drives and wheels or alternately may be a combination of servo or stepper drives utilizing belts, transmissions or otherwise. One or more casters 586 may be provided to stabilize mobile robot 570 as it moves around on a horizontal surface. As previously described pinions or gears 590, 592 may extend or retract 594, 596 where when extended pinions are gears 590, 592 engage rack features in the totes 600. In alternate embodiments any suitable vertical traction method may be used for example timing belts having teeth on both sides that on the drive side engage a servo or stepping motor and where on the climbing side engage mating features to the belt teeth that are contained on the totes 600. In alternate aspects, any suitable vertical traction drive may be provided. Climbing pinions 590, 592 may be driven by a drive gear and motor 720 where drive motor 720 may be any suitable rotary drive for example a servo or stepper drive with a gear motor, belt or otherwise. Drive gear and motor 720 drives climbing pinions 592 by rotating gear 724 such that drive gear and motor 720, gear 724 and pinion 590 are in meshing engagement as a gear train. Drive gear and motor 720 similarly drives climbing pinions 590 via rotating gears 728, 730 such that drive gear and motor 720, gear 728, 730 and pinion 590 are in meshing engagement as a gear train. As drive gear and motor 720 are rotated, climbing pinion 592 rotates in the same direction whereas climbing pinion 590 rotates in the opposite direction thus enabling pinions 590 and 592 to engage opposing racks as part of totes 600 (not shown). Housing 734 is movable 594, 596 with respect to housing 576 where housing 734 has bearings that constrain rotation of gear 724 and pinion 592. Similarly, housing 732 is movable 594, 596 with respect to housing 576 where housing 732 has bearings that constrain rotation of gears 728, 730 and pinion 590. Drive gear and motor 720 rotate to enable climbing via pinion 590, 592. Extension and retraction 596, 594 of pinions 592, 590 is accomplished by moving drive gear and motor 720 in a plus or minus Z direction with a separate Z drive that may be a lead screw drive or other suitable drive. Extension and retraction 596, 594 of pinions 592, 590 will be shown with respect to FIGS. 65A-65C, in accordance with some embodiments. In FIG. 65A, climbing pinions 590 and 592 are shown in a retracted position, in accordance with some embodiments. As seen in FIGS. 65B and 65C, as drive gear and motor 720 move upward in the Z direction pinions 590 and 592 are pushed out to an extended position as seen in FIG. 65C, in accordance with some embodiments.

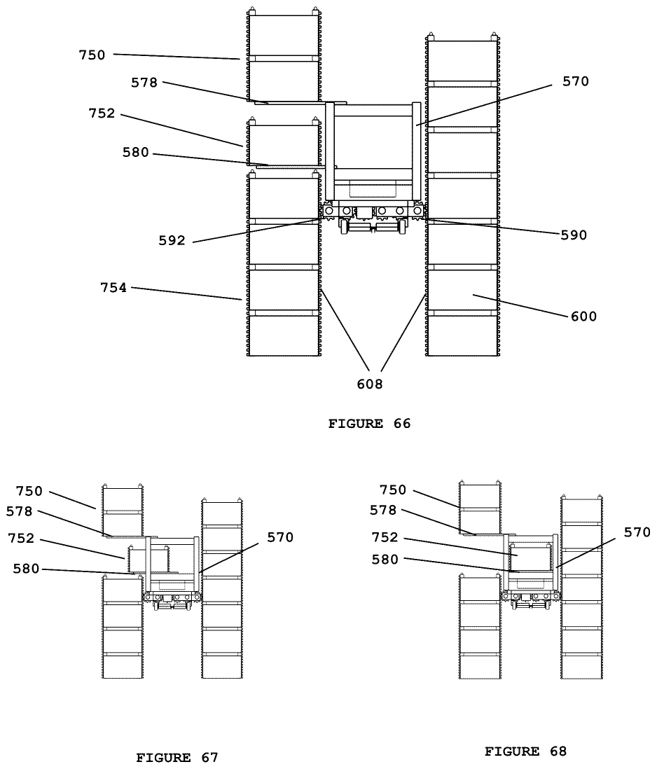

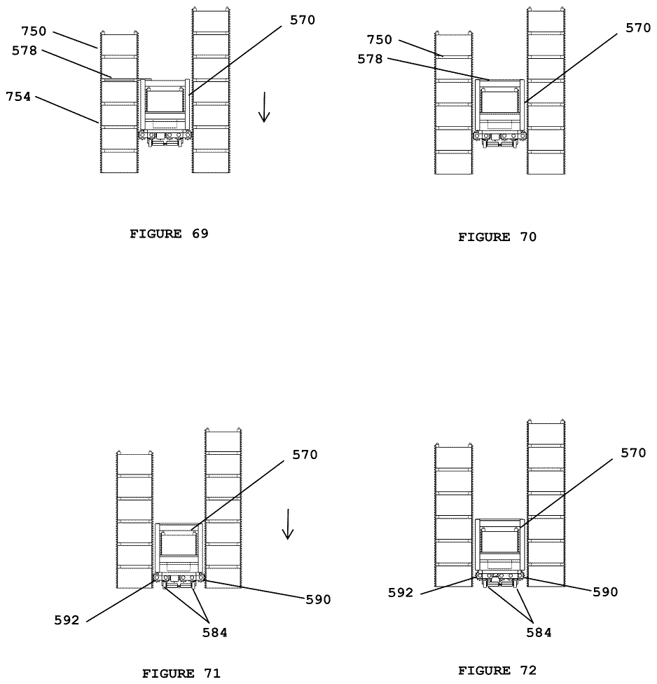

FIGS. 66 to 72 show mobile robot 570 retrieving a tote from tote stacks in storage, in accordance with some embodiments. Referring now to FIG. 66, mobile robot 570 is shown with its climbing pinions 590, 592 extended and climbing stacks of totes 600 via rack features 608 in totes 600. Mobile robot 570 is shown with upper tote transfer arm 578 extended and having raised tote stack 750. Mobile robot 570 is further shown with lower tote transfer arm 580 extended and having raised target tote 752 above the remaining lower tote stack 754. In FIG. 67 lower tote transfer arm 580 retracts with target tote 752 until lower transfer arm 580 is fully retracted as seen in FIG. 68. In FIG. 69 mobile robot 570 claims down utilizing climbing pinions 590, 592 until after stack 750 is placed on lower stack 754. In FIG. 70 upper tote transfer affirmed 578 is retracted. In FIG. 71 mobile robot 570 utilizes climbing pinions 590, 592 to lower bot 570 until traction drives 584 are supported by the floor. In FIG. 72, mobile robot 570 retracts climbing pinions 590, 592 as traction drives 584 are now supporting mobile robot 570. With mobile robot 570 on the floor, traction drives 584 may now move mobile robot 572 any suitable destination such as a workstation or otherwise being driven autonomously by traction drives 584.

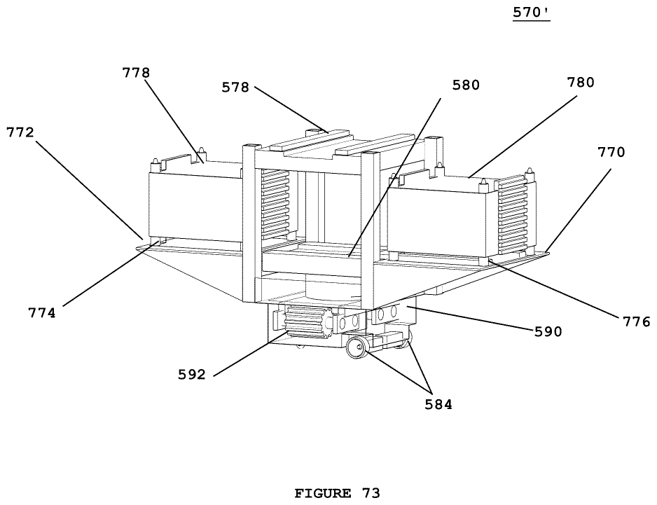

Referring now to FIG. 73, there is shown an isometric view of mobile robot 570′, in accordance with some embodiments. Mobile robot has the same features as mobile robot 570 including without limitations upper tote lift arm 578, lower tote transfer arm 580, climbing pinions 590, 592 and traction drives 584. Additionally, two tote storage platforms 770, 772 are provided with each having tote nesting and locating features 774, 776 that positively locate and hold the position of totes placed thereon by lower tote transfer arm 580. Having two tote storage platforms 770, 772, mobile robot 570′ is capable of swapping totes within a storage structure. By way of non-limiting example, mobile robot 570′ may return from a workstation with tote 778 located on support 772 with support 770 empty where tote 778 may be a product tote destined for return to storage. With tote 780 being a different product tote located in a stack within storage, mobile robot can position in front of tote 780, utilize lift arm 578 to lift the stack above tote 780, pick tote 780 with tote transfer arm 580 and place tote 780 on support 770, pick tote 778 and place tote 778 in storage on the stack where tote 780 previously occupied, lower the stack now above tote 778 with arm 578 and exit storage with tote 780. In this manner, the number of moves to return a tote to storage and pick a new target tote minimizes the number of actions mobile robot needs to take to perform the transaction as compared to going to 2 destinations with the storage structure to perform the same operation.

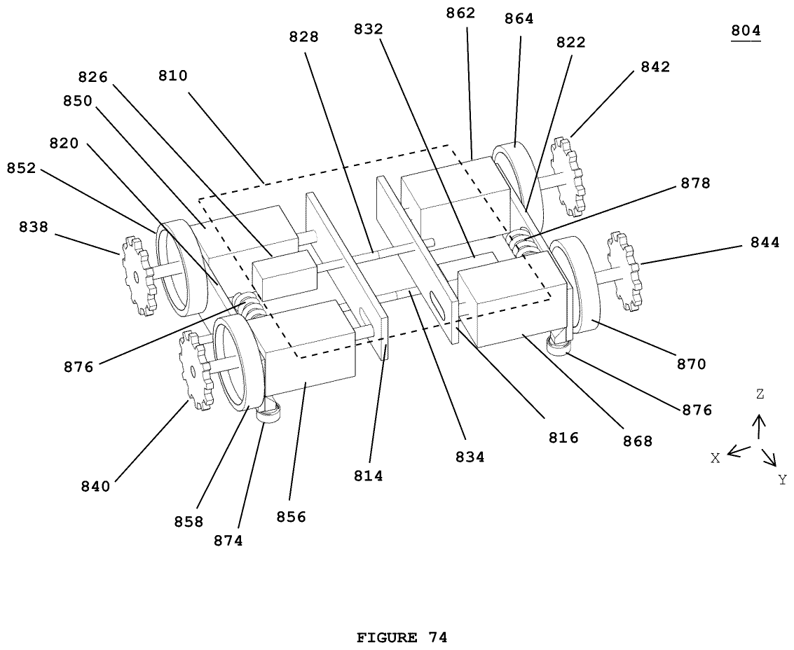

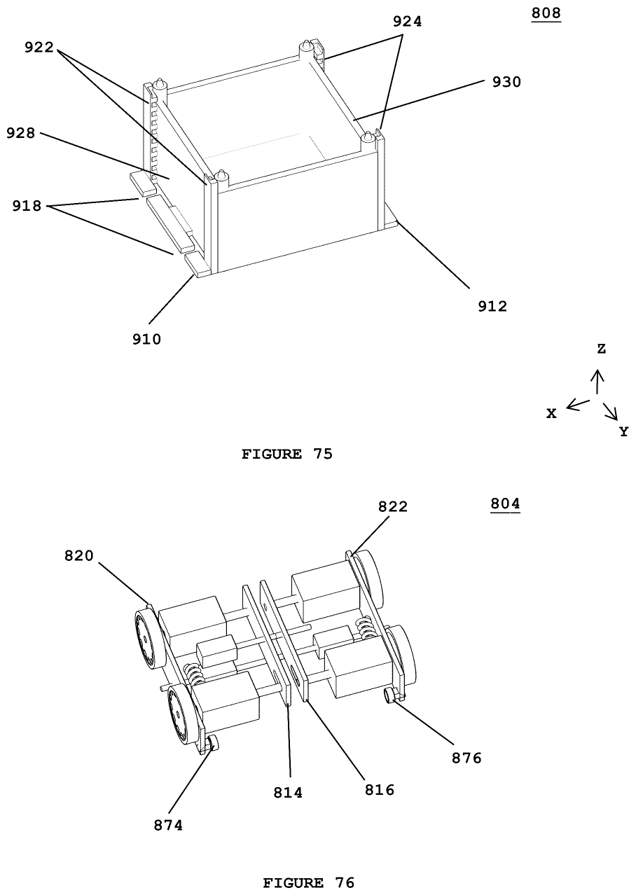

Referring now to FIG. 74, there is shown an isometric view of a portion of a transport and climbing mechanism 804 that is configured to climb totes, in accordance with some embodiments. Referring also to FIG. 75, there is shown an isometric view of a tote 808 configured to be compatible with transport and climbing mechanism 804, in accordance with some embodiments. Transport and climbing mechanism 804 may be used in combination with tote transport and lifting arms as previously described as well as buffered shelving associated with tote transport and lifting arms as previously described; however transport and climbing mechanism 804 is shown without such structure for clarity where such exemplary structure will be described below in greater detail. Transport mechanism 804 has frame 810 (shown in phantom) with first and second climbing carriages 814, 816 coupled to frame 810 with slides (not shown) that constrain first and second climbing carriages 814, 816 to be movable each in a +/−X direction. Transport mechanism 804 further has first and second drive wheel carriages 820, 822 coupled to frame 810 with slides (not shown) that constrain first and second drive wheel carriages 820, 822 to be movable each in a +/−X direction. Climbing carriage drive motor 826 is grounded to frame 810 where climbing carriage drive motor 826 has lead screw 828 with left and right hand lead portions engaged with first and second climbing carriages 814, 816. When carriage drive motor 826 rotates lead screw 828 in a first direction, first and second climbing carriages 814, 816 extend away from each other in a +/−X direction. When carriage drive motor 826 rotates lead screw 828 in a second direction opposite the first direction, first and second climbing carriages 814, 816 retract toward each other in a −/+X direction. Similarly, drive wheel carriage drive motor 832 is grounded to frame 810 where drive wheel carriage drive motor 832 has lead screw 834 with left and right hand lead portions engaged with first and second drive wheel carriages 820, 822. When carriage drive motor 832 rotates lead screw 834 in a first direction, first and second drive wheel carriages 820, 822 extend away from each other in a +/−X direction. When carriage drive motor 832 rotates lead screw 834 in a second direction opposite the first direction, first and second drive wheel carriages 820, 822 retract toward each other in a −/+X direction. Pinion 838 is coupled to a shaft that is rotationally coupled to first climbing carriage 814 such that as first climbing carriage 814 is extended and retracted in an X direction, pinion 838 extends and retracts with it but is free to rotate with respect to first climbing carriage 814. Pinion 840 is coupled to a shaft that is rotationally and slidingly in +/−Y coupled to first climbing carriage 814 such that as first climbing carriage 814 is extended and retracted in an X direction, pinion 840 extends and retracts with it but is free to rotate and slide in +/−Y with respect to first climbing carriage 814. Pinion 842 is coupled to a shaft that is rotationally coupled to second climbing carriage 816 such that as second climbing carriage 816 is extended and retracted in an X direction, pinion 842 extends and retracts with it but is free to rotate with respect to second climbing carriage 816. Pinion 844 is coupled to a shaft that is rotationally and slidingly in +/−Y coupled to second climbing carriage 816 such that as second climbing carriage 816 is extended and retracted in an X direction, pinion 844 extends and retracts with it but is free to rotate and slide in +/−Y with respect to second climbing carriage 816. First drive motor 850 is shown grounded to first drive wheel carriage 820 where first drive motor 850 drives both wheel 852 and climbing sprocket 838. Here, the shaft coupled to climbing sprocket 838 may be a spline shaft which allows transfer of torque from a spline of first drive motor 850 to climbing sprocket 838 while allowing the shaft coupled to climbing sprocket 838 to slide and move freely in a +/−X direction with respect to first drive motor 850. As applied, the disclosed spline shafts and drive arrangement combinations may be as disclosed in REFERENCE COMPLIANT PINION. Second drive motor 856 is shown slidingly coupled to first drive wheel carriage 820 in the +/−Y direction by a slide (not shown) where second drive motor 856 drives both wheel 858 and climbing sprocket 840. Here, the shaft coupled to climbing sprocket 840 may be a spline shaft which allows transfer of torque from a spline of second drive motor 856 to climbing sprocket 840 while allowing the shaft coupled to climbing sprocket 840 to slide and move freely in a +/−X direction with respect to second drive motor 856. Third drive motor 862 is shown grounded to second drive wheel carriage 822 where third drive motor 862 drives both wheel 864 and climbing sprocket 842. Here, the shaft coupled to climbing sprocket 842 may be a spline shaft which allows transfer of torque from a spline of third drive motor 862 to climbing sprocket 842 while allowing the shaft coupled to climbing sprocket 842 to slide and move freely in a +/−X direction with respect to third drive motor 862. Fourth drive motor 868 is shown slidingly coupled to second drive wheel carriage 822 in the +/−Y direction by a slide (not shown) where fourth drive motor 868 drives both wheel 870 and climbing sprocket 844. Here, the shaft coupled to climbing sprocket 844 may be a spline shaft which allows transfer of torque from a spline of fourth drive motor 868 to climbing sprocket 844 while allowing the shaft coupled to climbing sprocket 844 to slide and move freely in a +/−X direction with respect to fourth drive motor 868. Linear actuators 876, 878 are coupled at one end to second and fourth drive motors 856, 868 and at the other end grounded to first and second drive wheel carriages 820, 822 respectively. Linear actuator 876 selectively moves and positions second drive motor 856 and hence climbing pinion 840 and drive wheel 858 in a +/−Y direction. Linear actuator 878 selectively moves and positions fourth drive motor 868 and hence climbing pinion 844 and drive wheel 870 in a +/−Y direction. In one aspect, linear actuators 876, 878 may be springs as shown where the springs are compressed or extend by selectively moving wheels 852, 858 and 864, 870 respectively relative to each other causing the springs to compress, extend or decompress in the Y direction. In alternate aspects, linear actuators 876, 878 may be active actuators, such as electrically driven ball screws or otherwise. Although 4 drive wheels 852, 858, 864, 870 are shown, in alternate aspects, only two drive wheels may be provided where one or more caster may be provided instead of the other two drive wheels. Although 4 drive motors 850, 856, 862, 868 are shown, in alternate aspects, only two drive motors may be provided, for example, where the two drive motors drive two sprockets and the remaining two sprockets are slaved off of them with timing belts, gears or other suitable power transmission arrangement. Guide or centering rollers 874, 876 may be provided coupled to first and second drive wheel carriages 820, 822 respectively in order to center or guide transport mechanism 804 when moving on guides or rails for example. First and second drive wheel carriages 820, 822 may be coupled by a rotary actuator or mechanism that selectively rotates them out of the way, for example 90 degrees or otherwise in a direction about the Y axis or otherwise to retract them such that they do not interfere with the surface drive wheels 852, 858, 864, 870 are driving transport mechanism 804.

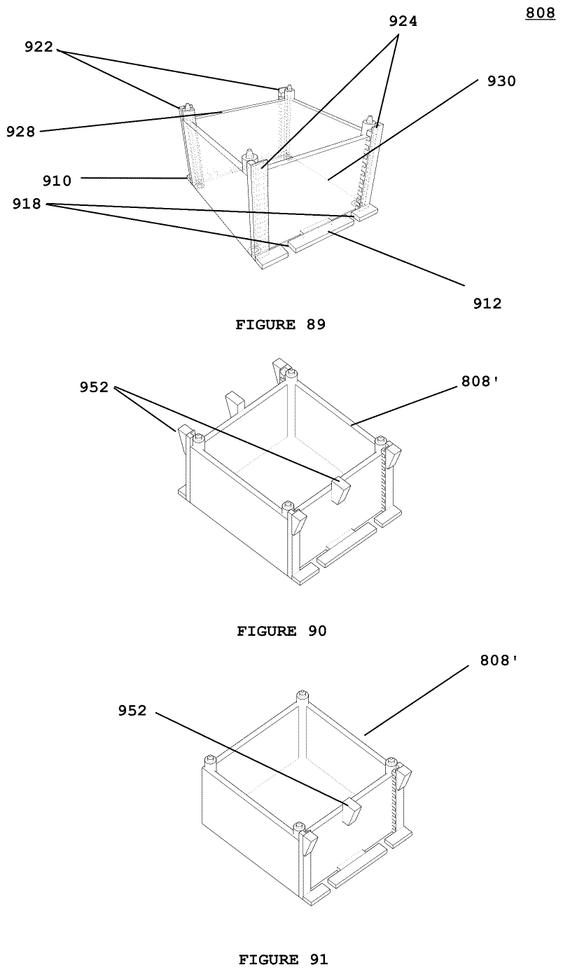

Referring now to FIGS. 75 and 89, there is shown tote or container 808 that has features that interface with transport mechanism 804 to allow it to climb up or down past or traverse by tote or container 808, in accordance with some embodiments. Tote 808 has opposing first and second rails 910, 912 that have support surfaces configured to support drive wheels. T shaped slots 918 are provided on opposing first and second rails 910, 912 that allow pinions or sprockets and their associated drive shafts to pass through rails 910, 912 as the pinions or sprockets move vertically past tote 808. First and second opposing climbing racks 922, 924 are formed or coupled to first and second tote walls 928, 930 where first and second opposing climbing racks 922, 924 mesh with pinions or sprockets as they move vertically past tote 808 and where axial forces associated with first and second opposing climbing racks 922, 924 as they mesh with pinions or sprockets and where the resulting opposing forces are reacted through walls 928, 930.

Referring now to FIGS. 76 and 88 there are shown isometric and top views respectively of transport and climbing mechanism 804 in a configuration to drive on a surface or deck with climbing sprockets in and drive wheels retracted or driven in, in accordance with some embodiments. Here, first and second climbing carriage 814, 816 have been retracted toward each other as well as first and second drive wheel carriages 820, 822 that have been retracted toward each other. Guide wheels 874, 876 are also shown rotated about the Y axis such that first and second drive wheel carriages 820, 822 are retracted such that they do not interfere with the surface drive wheels 852, 858, 864, 870 driving transport mechanism 804 on the surface.

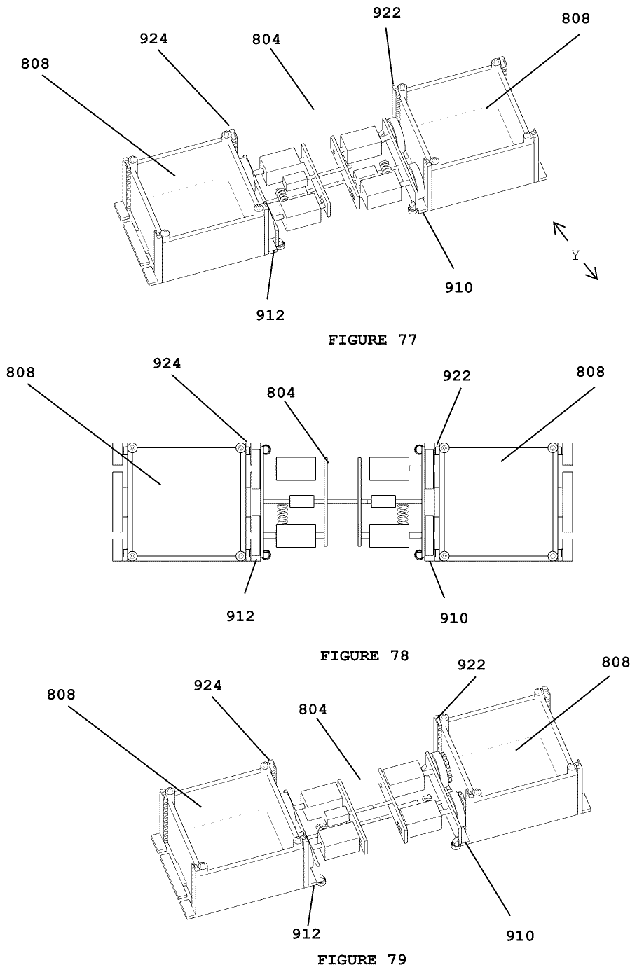

Referring now to FIGS. 77 and 78, there is shown isometric and top views respectively of transport mechanism 804 travelling on totes 808, in accordance with some embodiments. Transport mechanism 804 is shown with the drive wheels extended to a position where the drive wheels are supported by rails 910, 912. Transport mechanism 804 is shown with guide rollers lowered to interface with the sides of rails 910, 912. Transport mechanism 804 is shown with the pinions retracted inside of the drive wheels such that as transport mechanism 804 utilizing the drive wheels moves in a Y direction the pinions do not interfere and pass by the climbing racks 922, 924 of totes 808.

Referring now to FIGS. 79 and 80, there is shown isometric and top views respectively of transport mechanism 804 travelling on totes 808, in accordance with some embodiments. Transport mechanism 804 is shown with the drive wheels extended to a position where the drive wheels are supported by rails 910, 912. Transport mechanism 804 is shown with guide rollers lowered to interface with the sides of rails 910, 912. Transport mechanism 804 is shown with the pinions extended to be aligned with the climbing racks 922, 924 of totes 808 but not yet engaged with the climbing racks 922, 924 of totes 808.

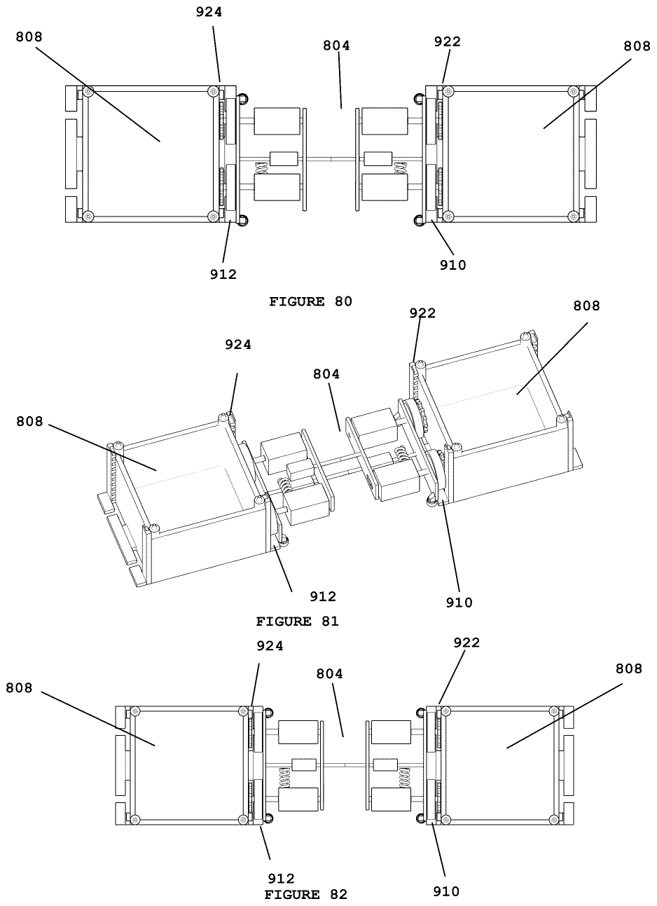

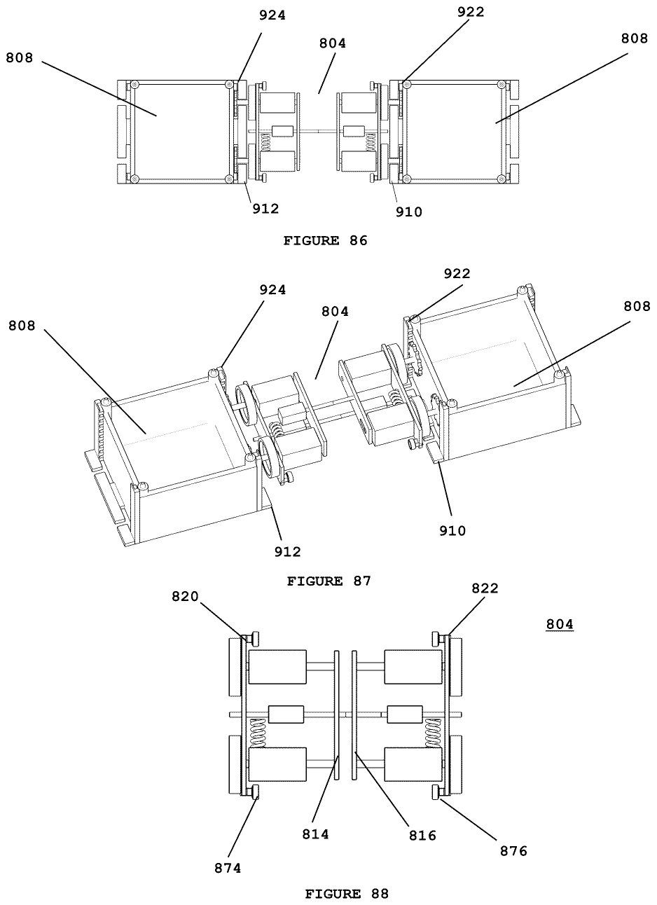

Referring now to FIGS. 80 and 81, there is shown isometric and top views respectively of transport mechanism 804 travelling on totes 808, in accordance with some embodiments. Transport mechanism 804 is shown with the drive wheels extended to a position where the drive wheels are supported by rails 910, 912. Transport mechanism 804 is shown with guide rollers lowered to interface with the sides of rails 910, 912. Transport mechanism 804 is shown with the pinions extended to be aligned with the climbing racks 922, 924 of totes 808 and engaged with the climbing racks 922, 924 of totes 808. Here, transport mechanism 804 may now climb climbing racks 922, 924 and with the drive wheels retracted and totes stacked can climb up multiple totes as seen in FIGS. 86 and 87 (stacked tote not shown), in accordance with some embodiments.

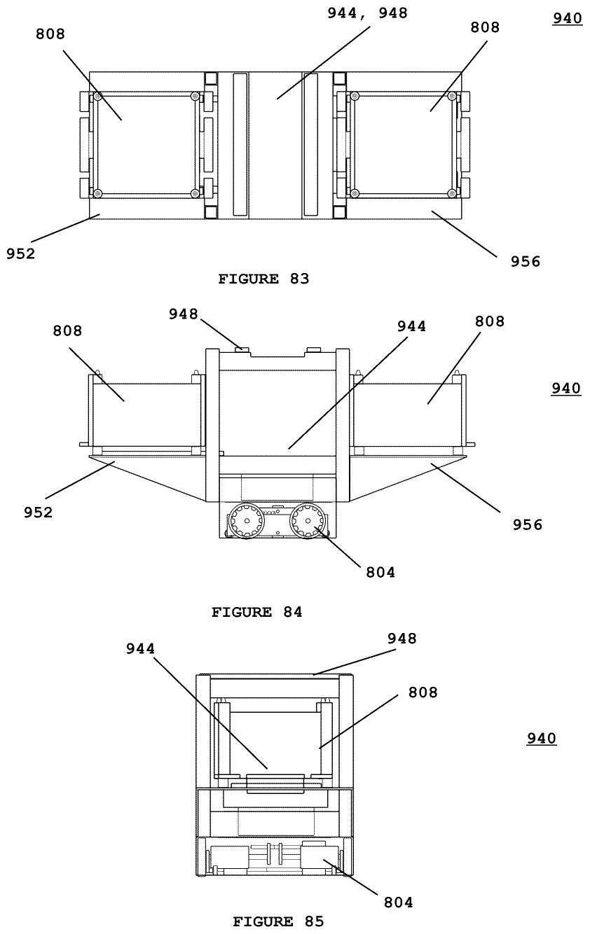

Referring now to FIGS. 83, 84 and 85 there is shown top, side and end views of tote transport robot 940, in accordance with some embodiments. Referring also to FIG. 98 there is shown an isometric view of tote transport robot 940 having caster(s) 1004, in accordance with some embodiments. Tote transport robot 940 utilizes transport mechanism 804 to move on surfaces, rails of totes and climbing racks on totes. Tote transport robot 940 has tote transport arm 944 and tote lifting arm 948 which may be as earlier described. Further, tote transport robot 940 has support shelves 952, 956 that support totes 808 where transport arm may selectively pick or place totes from a tote stack and pick or place to support shelves 952, 956.

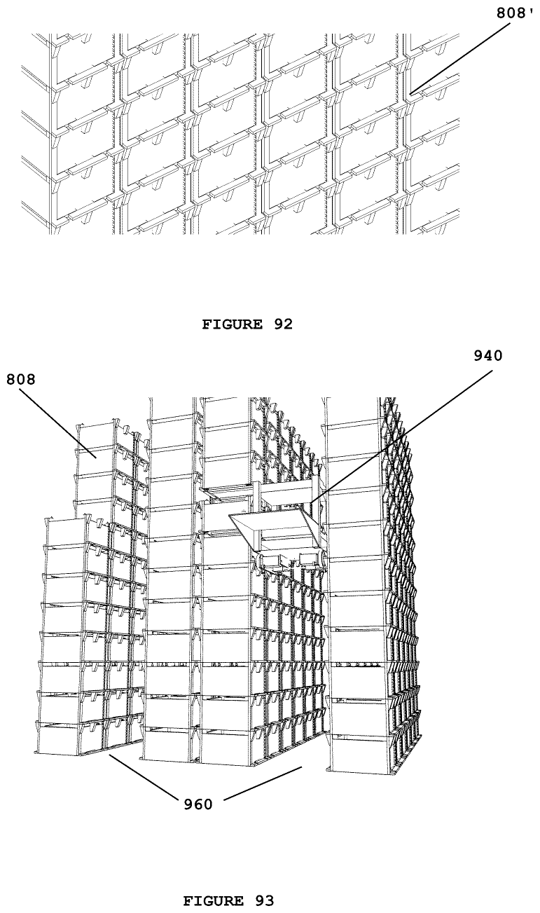

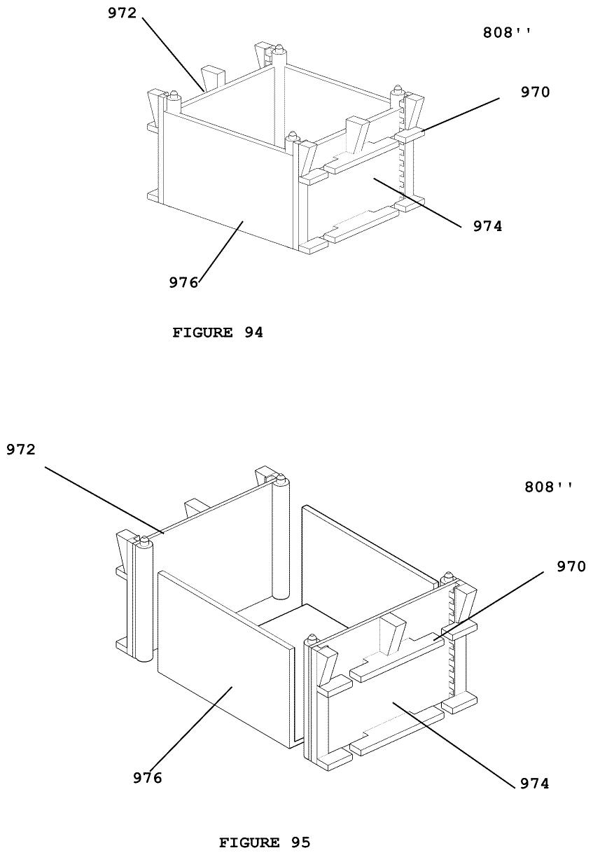

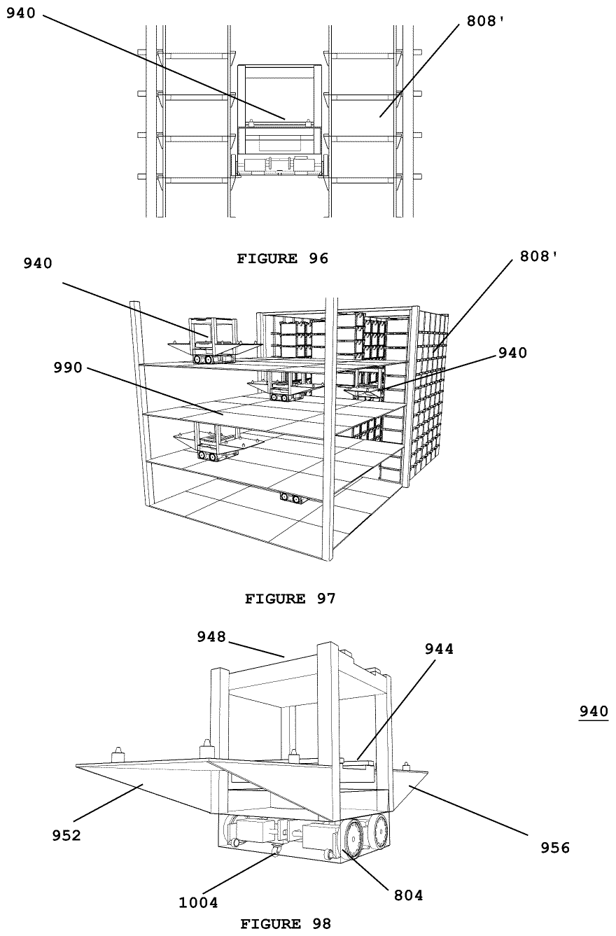

Referring now to FIGS. 90 and 91 there is shown isometric views of tote 808′, in accordance with some embodiments. Tote 808′ may have features as tote 808 but adds gussets 952 where gussets 952 are configured to support the rails of a tote stacked on it where 3 gussets support the 3 portions of the rail of the tote stacked on tote 808′. Referring also to FIG. 92, there is shown totes 808′ stacked with rows of tote stacks, in accordance with some embodiments. The rails form a substantially continuous rail surface for transport bot 940 to traverse horizontally on while the racks form a substantially continuous rack for transport bot 940 to climb vertically. Referring also to FIG. 93, there is shown totes 808′ stacked with rows of tote stacks and forming aisles where transport robot 940 may climb or traverse the tote stacks, in accordance with some embodiments. Referring also to FIGS. 94 and 95, there is shown tote 808″ in isometric and exploded views, in accordance with some embodiments. Tote 808″ has an additional rail 970 that is provided to prevent the drive wheels of transport robot 940 from tipping when a moment is applied, for example from a tote stack or otherwise. The additional rail 970 also provides a different surface for guide rollers. Tote 808″ further is made as a composite structure where, for example, walls 972, 974 may be made of a material such as aluminum or otherwise to handle the loads associate with the tote stack and where saddle 76 may be polypropylene or any suitable material. Referring also to FIG. 96 there is shown an end view with tote climber bot 940 traversing on the rails of totes 808′, in accordance with some embodiments. Referring also to FIG. 97 there is shown an end view with tote climber bot 940 traversing on the rails of totes 808′ and also the tote climber bot 940 on transit planes 990, in accordance with some embodiments.

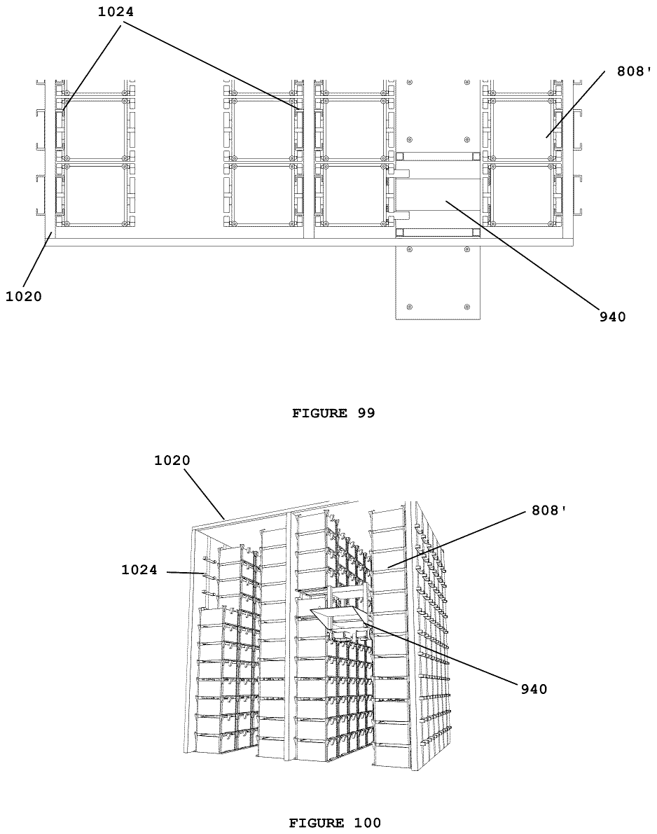

Referring now to FIGS. 99 and 100 there are shown end and isometric views of transport bot 940 traversing on the rails of totes 808′, in accordance with some embodiments. Seismic structure 1020 is shown with spaced hooks 1024 that cooperate with the T shaped slots 918 of tote 808′ to prevent the tote stacks from falling over during a seismic event.

Referring now to FIG. 102, there is shown an isometric view of an exemplary vertical swap bot 1030, in accordance with some embodiments. Tote transport bot 1030 has first and second tote transfer arms 1042, 1044 and tote stack lift arm 1048. In operation, first and second tote transfer arms 1042, 1044 may be used to pick two totes from a tote stack or swap totes within a tote stack, for example where bot 1030 arrives at a tote stack with a tote on arm 1042, picks a target tote with arm 1044 and places the tote on arm 1042 on the stack.

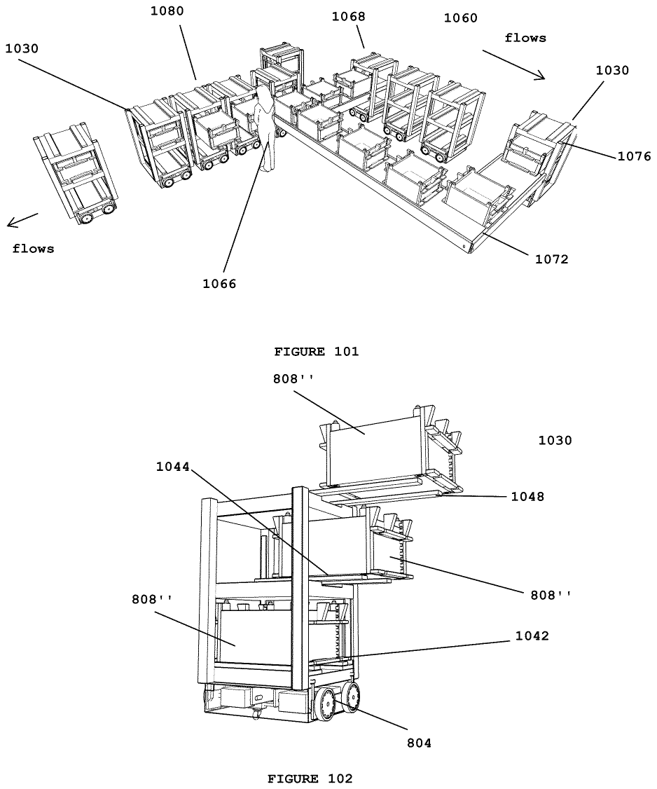

Referring now to FIG. 101, there is shown tote climber bots 1030 dynamic and static workstations 1060, in accordance with some embodiments. Operator 1066 sequentially picks eaches from product totes and places them on order totes. Product totes are dropped off by bot 1030 at location 1068 and are moved past the operator 1066 via conveyor 1072. Bots 1030 move from location 1068 to location 1076 to pick up the now depleted product totes for return to storage. Order totes are presented to operator 1066 at location 1080 such that as product totes flow by operator and eaches picked, the eaches forming an order are collected in the order tote(s). In alternate aspects, the flow may be reversed or the product and order sides reversed.

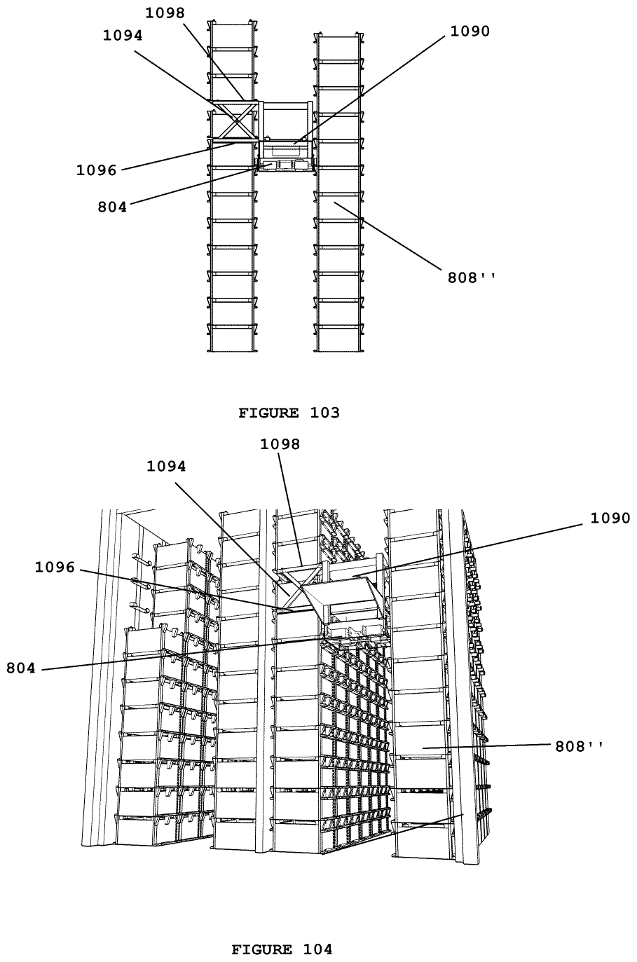

Referring now to FIGS. 103 and 104 there is shown tote climber bot 1090 having cage 1094 elevation and perspective views respectively, in accordance with some embodiments. Tote climber bot 1090 is shown picking a target tote where the tote lift arm of bot 1090 has a cage or scissors lift 1094. Lift 1094 has a lower portion 1096 that interfaces with the portion of the tote stack below the target tote. Lift 1094 has an upper portion 1098 that interfaces with the tote stack above the target tote. The cage or scissors lift 1094 extends with the tote lift arm and engages with the tote stacks below and above the target tote such that the load associated with lifting the stack is transferred directly to the portion of the stack below the target tote such that a moment is not applied to transfer robot 1090.

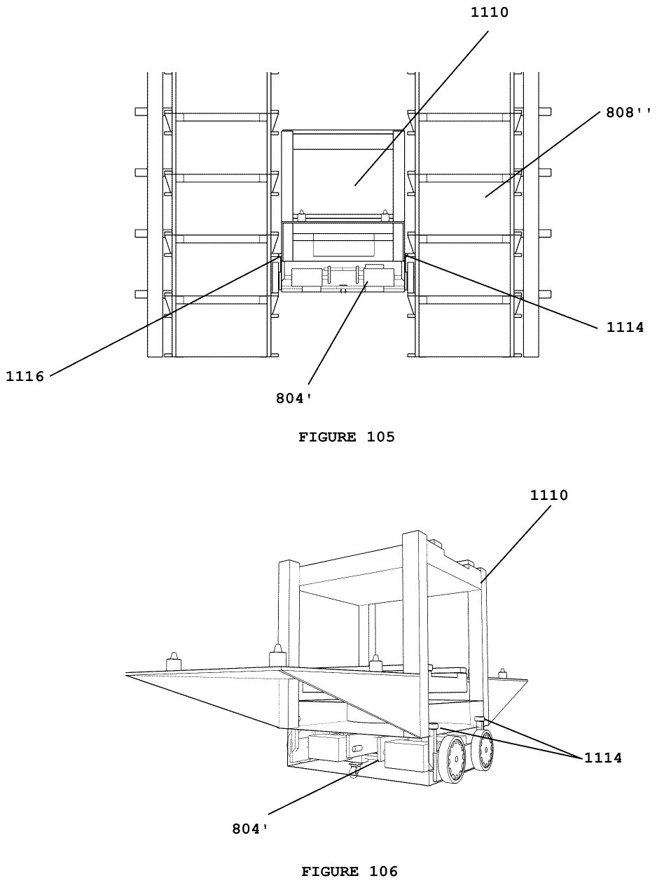

Referring now to FIGS. 105 and 106 tote climber bot 1110 is shown traversing on rails of totes 8089″ with upper guide wheels 1114, 1116, in accordance with some embodiments. Tote transfer robot 1110 has upper tote lifting arm and lower tote transfer arm and driven by drive mechanism 804′. Drive mechanism 804′ may have features as described with respect to mechanism 804 but with guide rollers 1114, 1116 that extend and retract with the drive wheels but and guide bot 1110 using the upper rails of totes 808″. As guide rollers 1114, 1116 are located above the drive wheels and extend and retract with the drive wheels, there is no need to rotate them out of the way as in drive or transport mechanism 804.

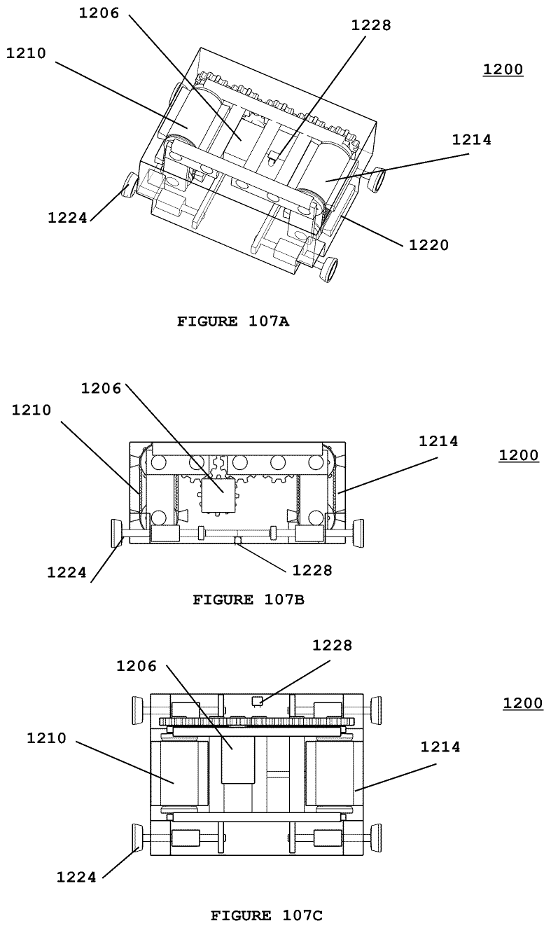

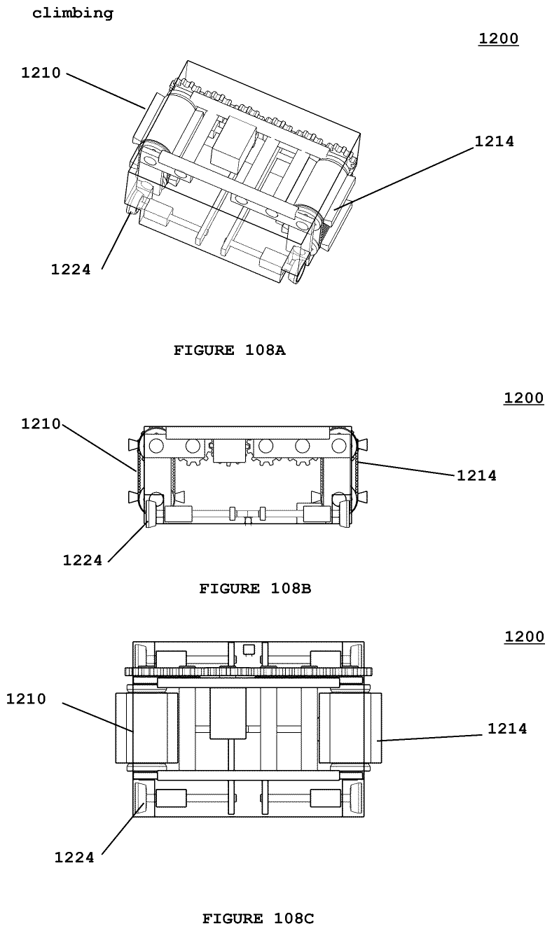

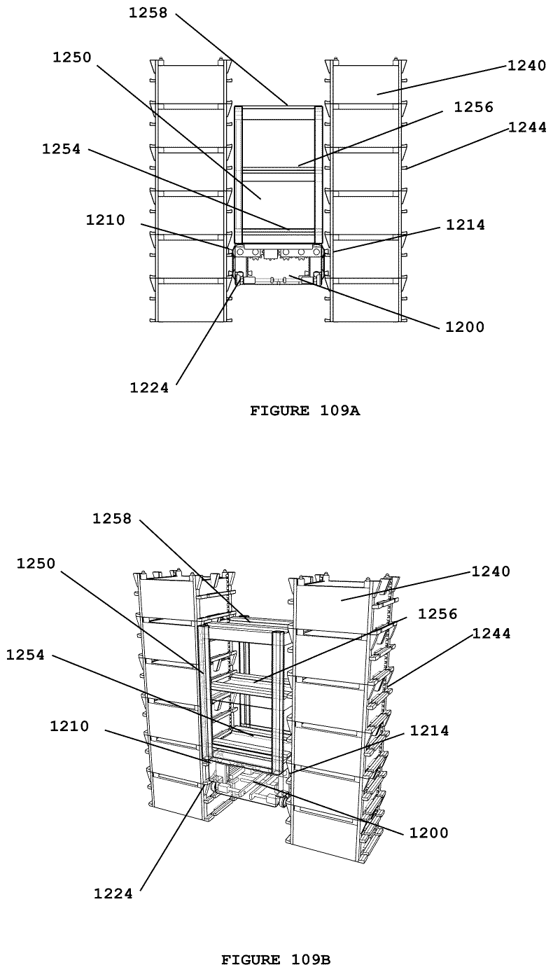

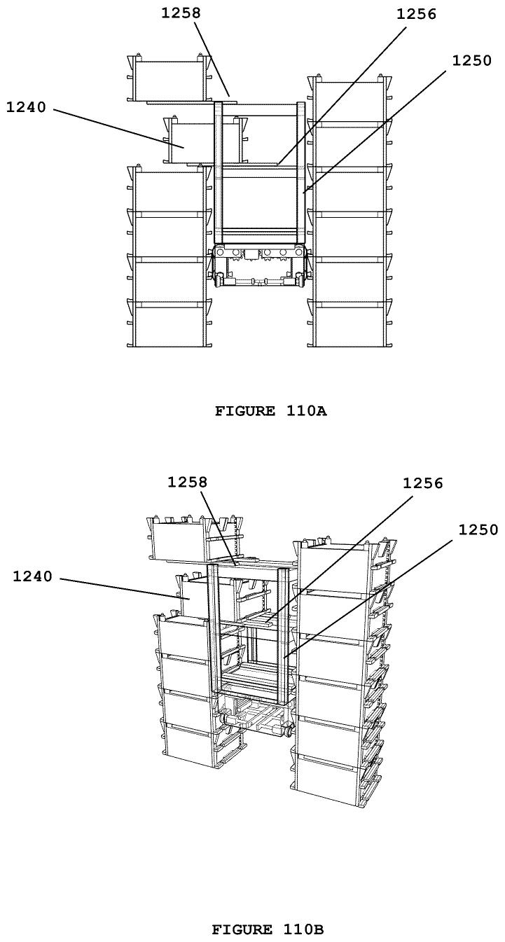

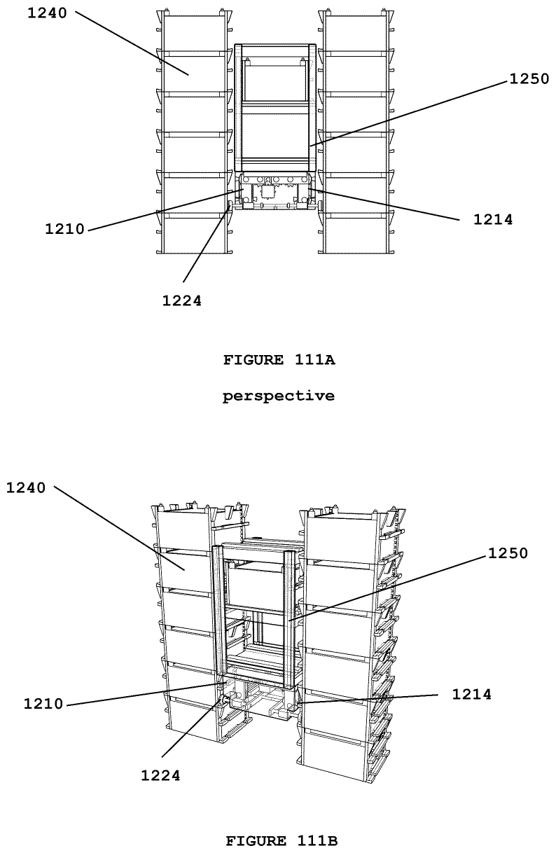

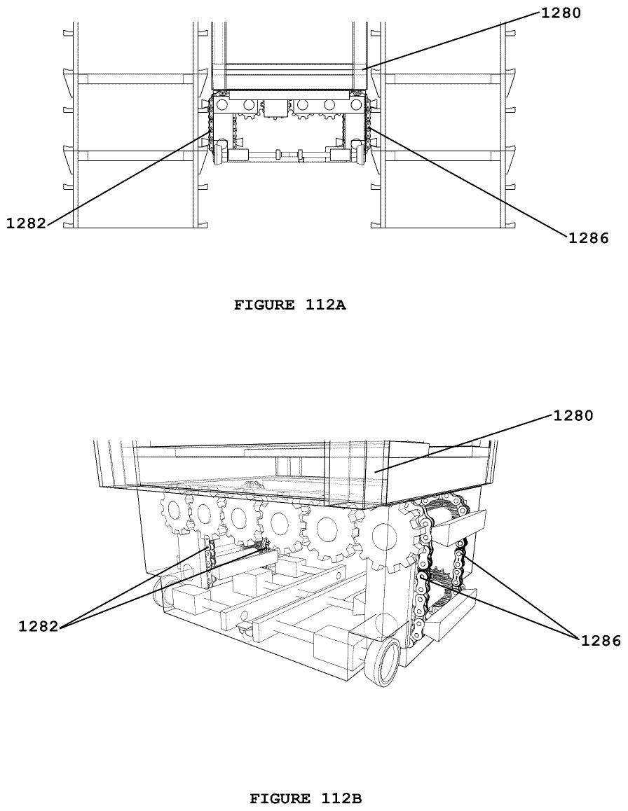

Referring now to FIGS. 107A, 107B and 107C there are shown perspective, end and top views of transport mechanism 1200 “centipede” implemented with climbing belts having climbing features as opposed to the pinions described with respect to transfer robot 570 to ensure adequate tote stack lift capacity and stability, in accordance with some embodiments. Similar to transfer robot 570, transport mechanism 1200 has vertical drive motor 1026 which utilizes a gear train to drive belts 1210, 1214 in opposite directions in order to climb. Similar to transfer robot 570, drive belts 1210, 1214 can be extended (a seen in FIGS. 108A-108C) to engage mating features on totes and retract to clear the features on the totes. Belts 1210, 1214 have wedge shaped protrusions 1220 that engage mating features on totes to climb. In alternate aspects, the protrusions 1220 may be rounded, form an involute or otherwise be provided with any suitable shape. Transport mechanism 1200 further has drive wheels 1224 that can be extended to drive on rails formed in the totes or on a surface such as a floor, deck or otherwise. Caster 1228 may be provided to raise 2 of the 4 drive wheels off the surface or deck such that transport mechanism 1200 can be driven and turned on the surface or deck. FIGS. 107A-107C show transport mechanism 1200 with drive wheels 1224 extended and climbing belts 1210, 1214 retracted in a state suitable to move on tote rails, in accordance with some embodiments. Referring also to FIGS. 108A-108C, bot 1200 is shown with drive wheels 1224 retracted and climbing belts 1210, 1214 extended in a state suitable to climb mating tote or structure features, in accordance with some embodiments. Referring also to FIGS. 109A-109B bot 1250 is shown with transport mechanism 1200 with drive wheels 1224 retracted and climbing belts 1210, 1214 extended in a state suitable to climb mating tote or structure features, in accordance with some embodiments. Totes 1240 are shown having climbing features 1244 that mate with the belts 1210, 1214 of transport mechanism 1200 enabling climbing. Tote transfer robot 1250 further has arms enabling tote swaps; first and second tote transfer arms 1254, 1256 and tote stack lift arm 1258. In operation, first and second tote transfer arms 1254, 1256 may be used to pick two totes from a tote stack or swap totes within a tote stack, for example where bot 1250 arrives at a tote stack with a tote on arm 1254, picks a target tote with arm 1256 and places the tote on arm 1254 on the stack. Referring also to FIGS. 110A-110B bot 1250 is shown with lift arm 1258 supporting a stack of totes and tote transfer arm 1256 picking a target tote 1240, in accordance with some embodiments. Referring also to FIGS. 111A-111B bot 1250 is shown with drive wheels 1224 extended and climbing belts 1210, 1214 retracted in a state suitable to move on tote rails as shown, in accordance with some embodiments. Referring now to FIGS. 112A and 112B, there are shown front and perspective views of tote transfer robot 1280, in accordance with some embodiments. Robot 1280 may have features similar to robot 1250 however instead of belts, drive chains 1282, 1286 are driven by sprockets to climb where climbing is accomplished similar to that shown with respect to bot 1250.

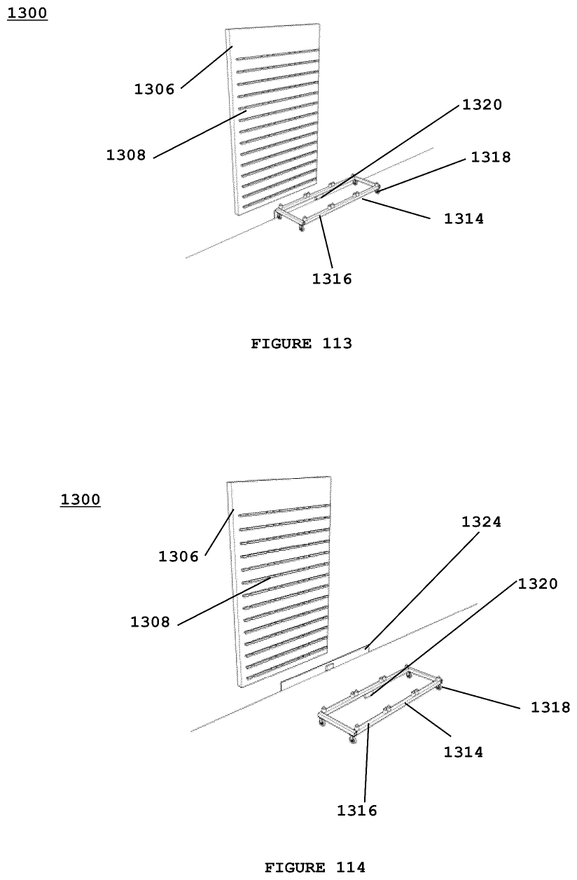

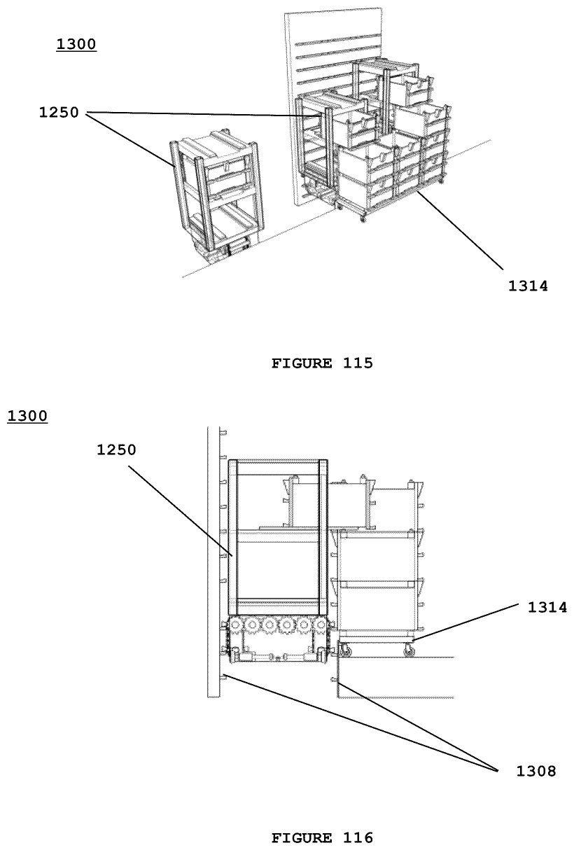

Referring now to FIGS. 113 and 114 there is shown a tote dolly loading station 1300, in accordance with some embodiments. Tote dolly loading station 1300 has climbing frame or rack 1306 which has climbing features which mimic the climbing features of a stack of totes (alternately rack 1306 may not be provided, for example where dolly's with totes replace the rack on both sides). Stacked tote dolly 1314 has a frame 1316 with tote supporting and locating features that is supported by casters 1318. A docking feature which may be ferrous metal or other suitable docking feature that mates with fixed docking latch or catch that may be mechanical or based on an electromagnet that positively locates dolly 1314 with respect to the docking station. Referring also to FIGS. 115 and 116 there is shown a tote dolly loading station 1300 with robots 1250 loading totes onto dolly 1314, in accordance with some embodiments. Here, robots 1250 climb on mating features 1308 of rack 1306 and below the dolly to pick or place totes with respect to dolly 1314.

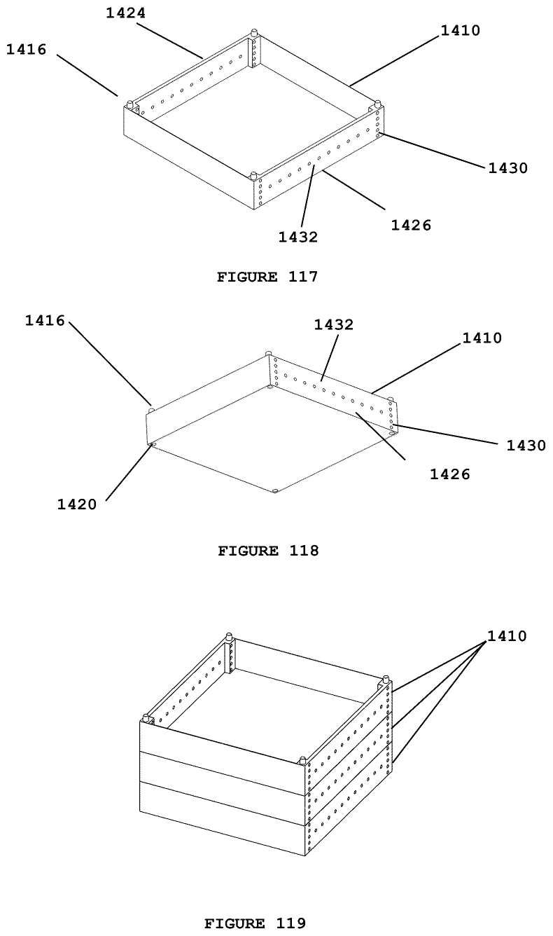

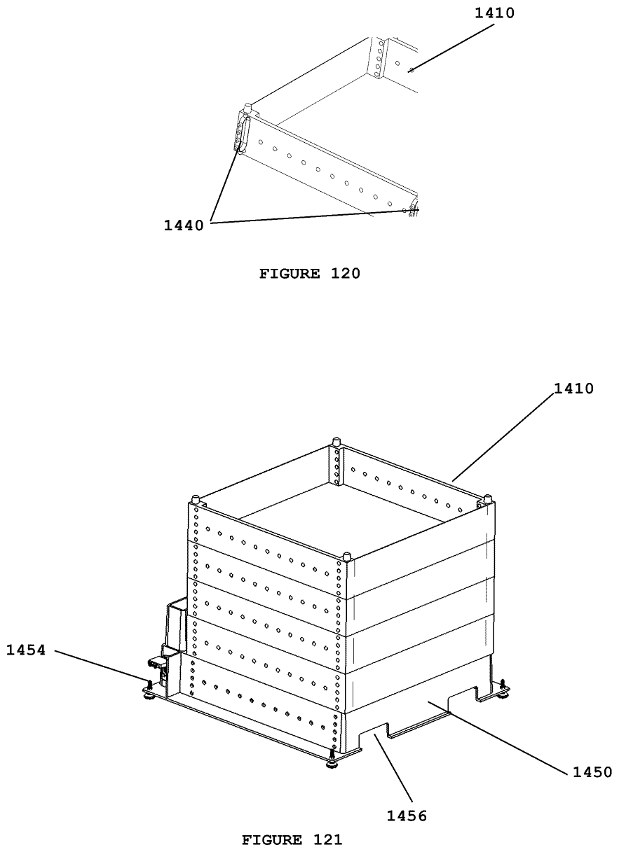

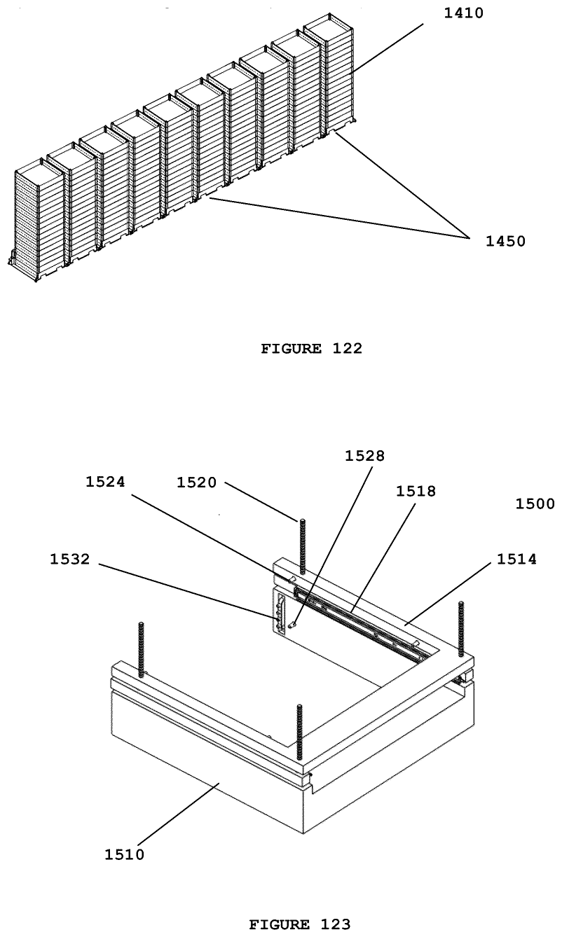

Referring now to FIGS. 117 and 118, “tractor feed” tote 1410 is shown in top and bottom perspective views respectively, in accordance with some embodiments. Referring also to FIG. 119, a stack of three “tractor feed” totes 1410 are shown, in accordance with some embodiments. The totes 1410 have locator pins 1416 on the upper side and mating holes 1420 on the bottom side that allow them to be stacked vertically. Two sides 1424, 1426 have vertical 1430 and horizontal 1432 hole patterns. As seen in FIG. 120, the vertical holes allow a robot to climb up a stack of totes using a gear or tractor feed 1440 (bot not shown for clarity), in accordance with some embodiments. The horizontal holes allow a tote to be pulled out of a stack. The holes can also be used to engage a pin into the side of the tote to attach the robot to the tote, either to lift the tote, or to support the robot using a tote below. As seen in FIG. 121, a base 1450 may be provided to stack totes 1410 on, in accordance with some embodiments. The base may, or may not contain an energy chain or retractable power cord 1454, to power and communicate to the robot climbing on the stack of totes. Fork openings 1456 may be provided to lift the entire stack with a fork truck or otherwise. As seen in FIG. 122, multiple bases and tote stacks can be arranged in the customers facility, either in one or multiple rows, in accordance with some embodiments. Here, the totes will sit on a base, that allows the stack to be leveled, or moved with a fork truck or pallet jack.

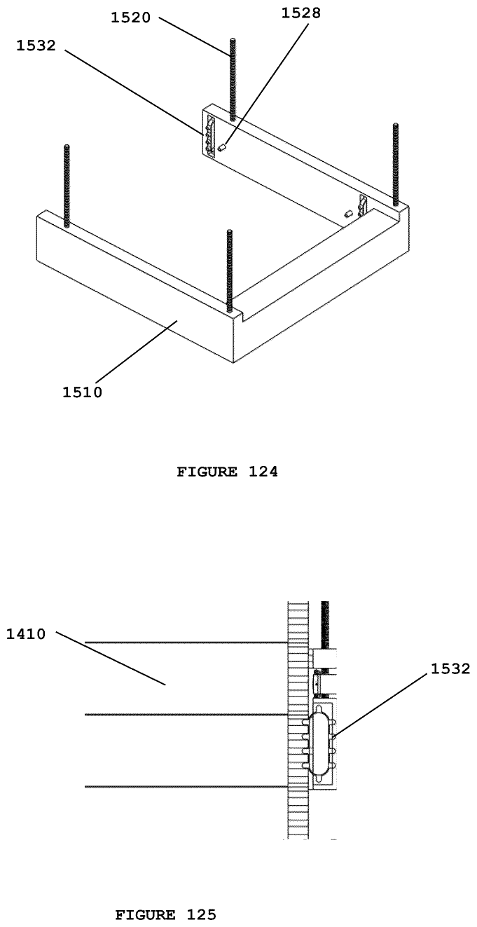

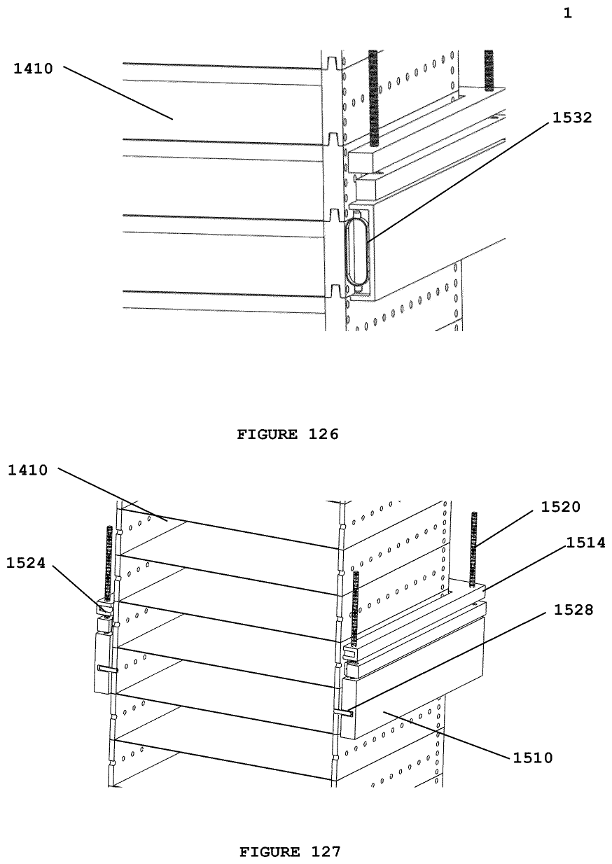

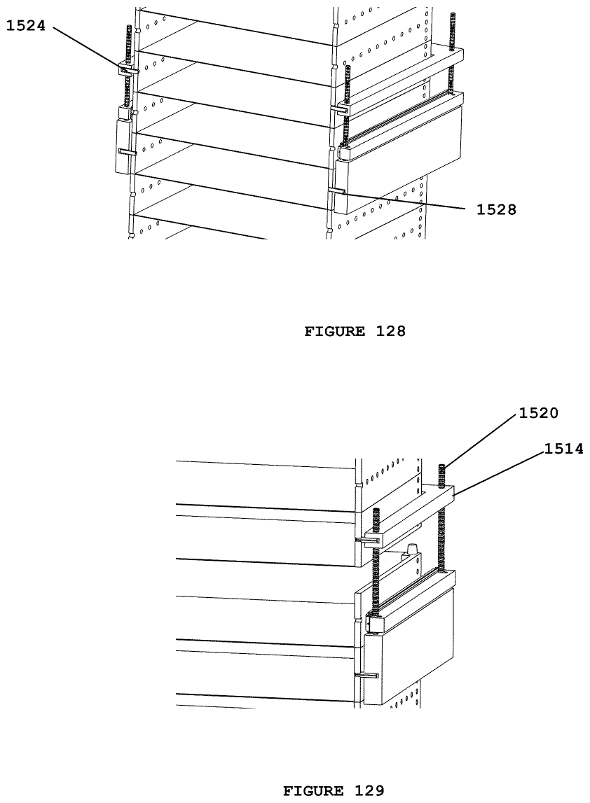

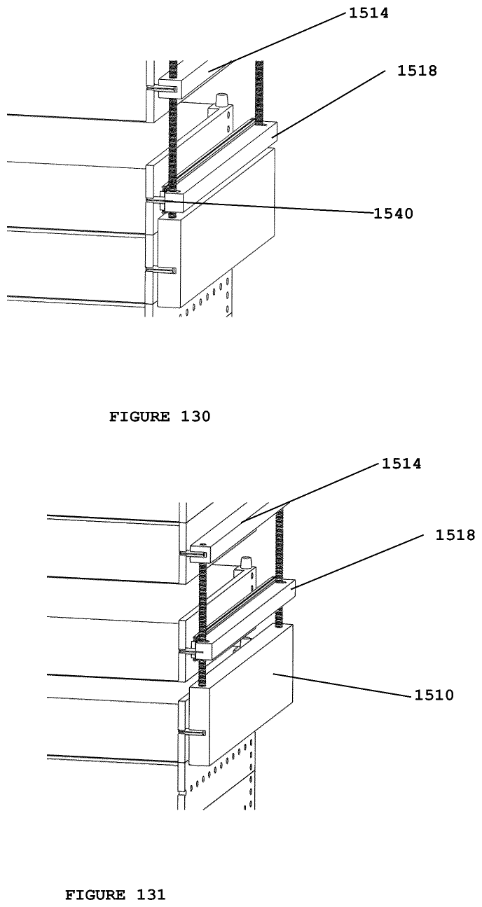

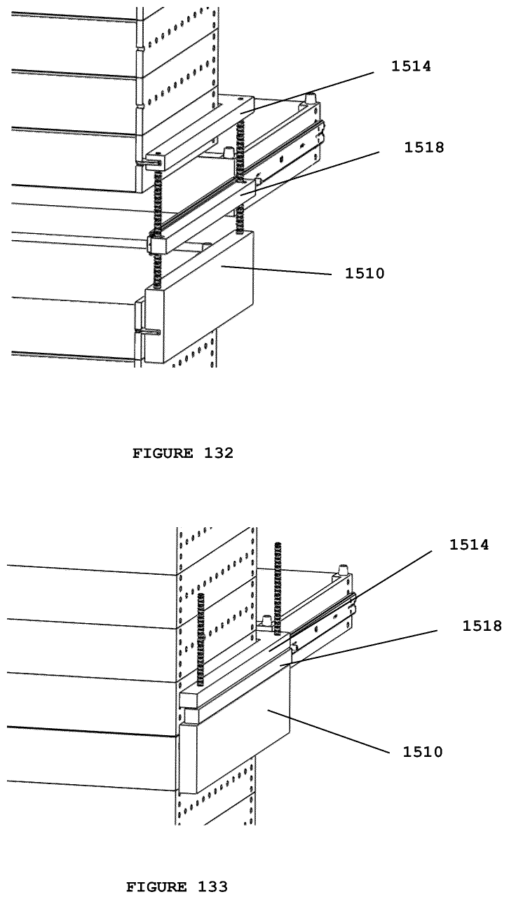

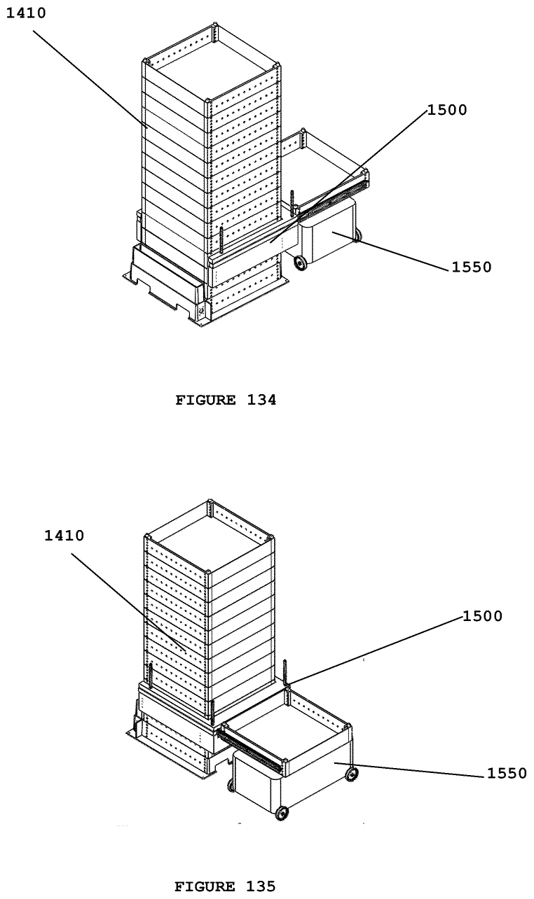

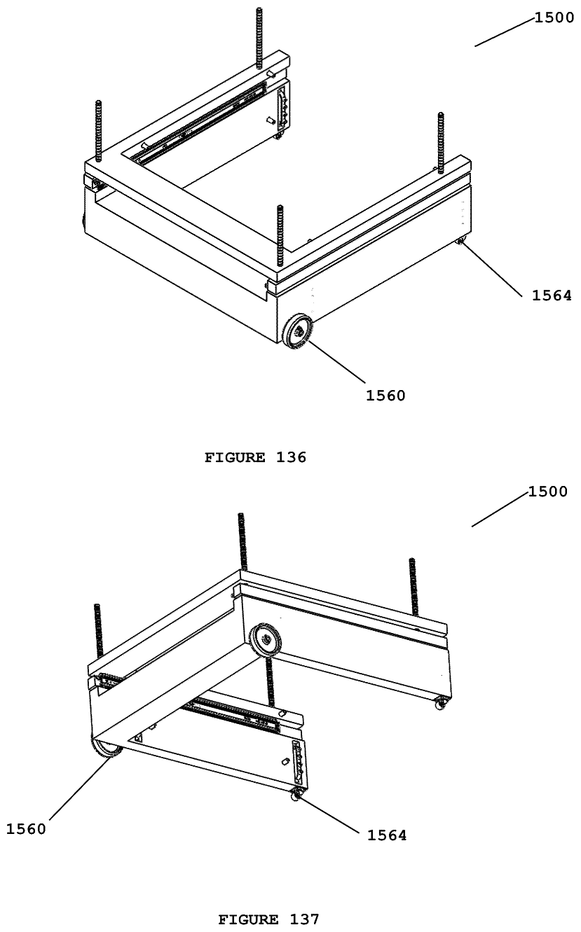

Referring now to FIG. 123, the stack of totes is climbed by a “Climber-Extractor” robot 1500, in accordance with some embodiments. Robot 1500 may have mobility features as previously described to allow robot 1500 to move autonomously on a surface (not shown for clarity). Robot 1500 has lower frame 1510, upper frame 1514 and tote extractor mechanism 1518, separator lead screws 1520 (4×), retractable upper stack lifting pins 1524 (4×), retractable lower stack lock pins 1528 (4×) and retractable climbing tractor feed 1532 (4×). Referring also to FIG. 124, the lower frame 1510 has four tractor feeds or gears 1532 that allows the climber extractor to drive vertically up the side of the stack of totes, in accordance with some embodiments. The holes in the side of the totes forms a continuous series of attachment points, allowing the tractor feed to travel seamlessly from one tote to the one above or below. As seen in FIGS. 125 and 126, the tractor feeds 1532 may be permanently positioned, so as to engage in the side of the totes, or they may be affixed to an extend/retract mechanism so that they can be disengaged, allowing the climber to detach from the stacks, in accordance with some embodiments. While traveling vertically, the Lower Stack Lock Pins 1528 are normally retracted. When the climber reaches the tote that is to be extracted (target tote), the pins 1528 engage into the tote below the target tote, effectively anchoring the climber to that tote. Note this function could be performed by applying a brake to the tractor feed, or other suitable anti-back drive mechanism, such as a worm drive; however engaging a separate pin may allow a more robust connection between the lower frame and the tote stack, primarily by putting the pin in shear, which prepares the lower frame to carry the full load of all the totes above it. Referring now to FIG. 127, once the lower frame 1510 is anchored to the tote stack, the leadscrews 1520 on the lower frame drive the upper frame 1514 to an appropriate height to engage the Upper Stack Lifting pins into the tote above the Target Tote, in accordance with some embodiments. The required height can be variable under software control, allowing the engagement of totes of varying heights. The pins may be actuated using a cam or eccentric that drives the pins together in sync. Referring also to FIG. 128, all 4 pins 1524 on the upper frame and 4 pins 1528 on the lower frame can be engaged simultaneously, assuming pre-positioned the upper and lower frame at the correct height so the pins can engage, in accordance with some embodiments. There may be a spline or square shaft drive that would transfer the engage motion between the lower frame and the upper frame. Referring also to FIG. 129, the Leadscrews 1520 then drive vertically, lifting the Upper Frame 1514, and the attached Tote Stack, and creating a Gap above the Target Tote, in accordance with some embodiments. Referring also to FIG. 130, the Extractor 1518 is flexibly coupled to the Upper Frame 1514, and as the Upper Frame lifts, it picks up the Extractor 1518, in accordance with some embodiments. The extractor is then moved vertically to a height where it can engage its own locking pins 1540 into the Target Tote. Alternately, this could be horizontal belt of tractor feed drive. Referring also to FIG. 131, the upper carriage 1514 is then driven further vertically, lifting the extractor 1518, along with the Target Tote, in accordance with some embodiments. This lifts the Target tote off of the Tote Stack below it, so the Target Tote is now free to move. Referring also to FIG. 132, now the Target Tote can be extracted from the Tote Stack by sliding it into the Aisle where the extractor is equipped with a slide and actuator to move the target tote, in accordance with some embodiments. Referring also to FIG. 133, now the Upper Frame can be lowered, until the remainder of the upper stack is engaged onto the lower stack, in accordance with some embodiments. Referring also to FIGS. 134 and 135, the upper and lower locking pins can now be disengaged from the Tote Stacks, allowing the crawler 1500 to travel down and place the Target Tote onto a mobile robot 1550 in the aisle, in accordance with some embodiments. The tote can now be disengaged and taken away by the Mobile Robot 1550. The process is fully reversable to return totes to the stack. Referring also to FIGS. 136 and 137, an embodiment can equip the climber 1500 with drive wheels 1560 and casters 1564 which allows it drive around the Tote Stack; here, one climber 1500 may service multiple stacks of Totes and transport the Target Tote directly to or from storage and picking station. Here, robot 1500 uses the casters 1564 and two differential drive wheels 1560 to steer and navigate 138.

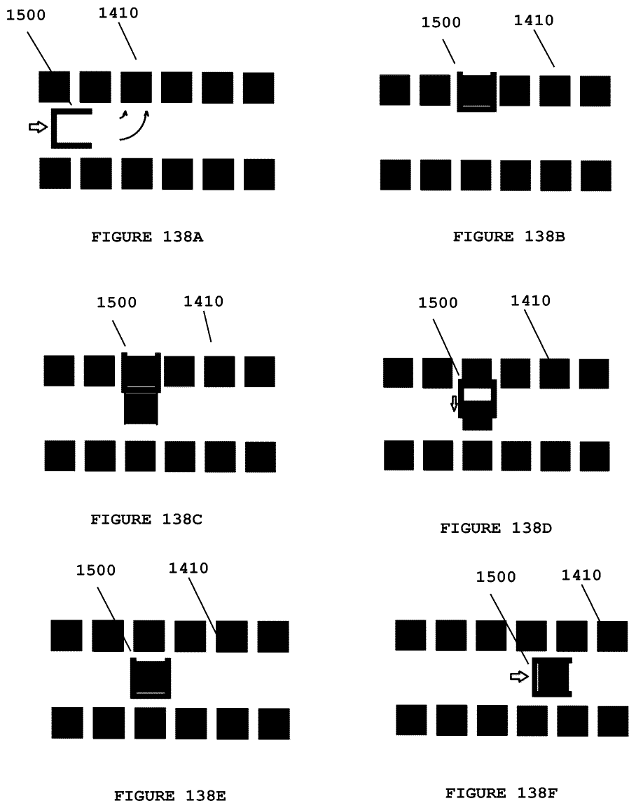

Referring now to FIGS. 138A-138F, a sequence of events is illustrated, in accordance with some embodiments:

Step 1 in FIG. 138A is the bot driving down the Aisle, and then turning into a stack.

Step 2 1 in FIG. 138B is the bot engaging and climbing the stack. The tractor-feed would also have to extend-retract to engage in the stack.

Step 3 in FIG. 138C is the bot retrieving the tote into the Aisle. It would then climb down to ground level with the tote.

Step 4 in FIG. 138D is the bot driving back into the Aisle. As it drives back the tote could retract onto the bot which minimizes the bot length

Step 5 in FIG. 138E is the bot in the Aisle.

Step 6 in FIG. 138F is the Bot turning and driving away.

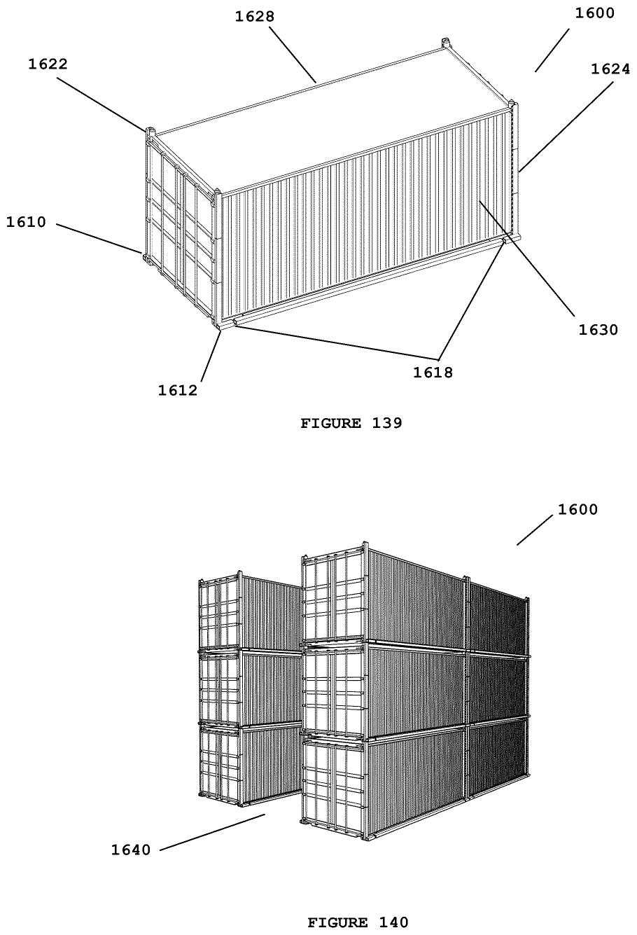

Referring now to FIG. 139, there is shown shipping container 1600, in accordance with some embodiments. Referring also to FIG. 140, there is shown stacks of shipping containers 1600, in accordance with some embodiments. Although the disclosed automation has been described with respect to totes, the automation may be scaled up or down to accommodate any suitable container, for example, shipping container 1600. Here, the embodiments may be scaled up or down, potentially to shipping containers or otherwise. Adding rail and climbing features onto shipping containers as we know them and developing a random access bot as disclosed to replace or supplement cranes. Container 1600 may have automation features as disclosed, for example with respect to container 808 of FIGS. 75 and 89. Container 1600 has features that interface with a transport mechanism to allow it to climb up or down past or traverse by container 1600. Container 1600 has opposing first and second rails 1610, 1612 that have support surfaces configured to support drive wheels. T shaped slots 1618 are provided on opposing first and second rails 1610, 1612 that allow pinions or sprockets and their associated drive shafts to pass through rails 1610, 1612 as the pinions or sprockets move vertically past container 1600. First and second opposing climbing racks 1622, 1624 are formed or coupled to first and second tote walls 1628, 1630 where first and second opposing climbing racks 1622, 1624 mesh with pinions or sprockets as they move vertically past container 1600 and where axial forces associated with first and second opposing climbing racks 1622, 1624 as they mesh with pinions or sprockets and where the resulting opposing forces are reacted through walls 1628, 1630. As previously disclosed, containers may be stacked and forming an aisle 1640 where a container transport robot may climb the containers within the aisle.

In accordance with an example embodiment a non-transitory program storage device readable by a machine may be provided, such as memory, for example, tangibly embodying a program of instructions executable by the machine for performing operations, the operations comprising: calculating routing of mobile robots and totes to stage and sequence mobile robots and totes as disclosed through the system.

Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Some embodiments provide an automated order fulfillment facility, comprising: a multi-level storage structure comprising a plurality of racks, and a mobile robot configured to transport totes to and from the multi-level storage structure. The mobile robot can comprise: a transport system configured to transport the mobile robot, a frame mounted on the transport system, a plurality of support locations vertically oriented within the frame, a first tote handling device comprising a first portion configured to extend from the frame and acquire a first tote from the multi-level storage structure, and a second tote handling device comprising a second portion configured to extend from the frame and support one or more totes second totes above the first tote as the first tote is being acquired.

Some embodiments provide methods of fulfilling orders, comprising: transporting, by a mobile robot, totes to and from a multi-level storage structure comprising a plurality of racks, each rack configured to store a plurality of vertically stacked totes; controlling a first tote handling device and extending a first portion of the first tote handling device from a frame of the mobile robot; acquiring, by the first portion while extended, a first tote from the multi-level storage structure controlling a second tote handling device and extending a second portion of the second tote handling device from the frame; and supporting, by the extended second portion of the second tote handling device, one or more second totes above the first tote as the first tote is being acquired by the first portion of the first tote handling device.

The foregoing detailed description has been presented for purposes of illustration and description. It is not intended to be exhaustive or to limit the description to the precise form disclosed. Many modifications and variations are possible in light of the above teaching. The described embodiments were chosen in order to best explain the principles of the claimed system and its practical application to thereby enable others skilled in the art to best utilize the claimed system in various embodiments and with various modifications as are suited to the particular use contemplated. It is intended that the scope of the method be defined by the claims appended hereto.

What is claimed is:

1. An automated order fulfillment facility, comprising:
a multi-level storage structure comprising a plurality of racks, each rack configured to store a plurality of vertically stacked totes; and
a mobile robot configured to transport totes to and from the multi-level storage structure, the mobile robot comprising:
a transport system configured to transport the mobile robot,
a frame mounted on the transport system,
a plurality of support locations vertically oriented within the frame,
a first tote handling device comprising a first portion configured to extend from the frame and acquire a first tote from the multi-level storage structure, and
a second tote handling device comprising a second portion configured to extend from the frame and support one or more totes second totes above the first tote as the first tote is being acquired.

2. The automated order fulfillment facility of claim 1, wherein the first tote handling device is configured to move vertically within the frame to acquire the first tote at different vertical positions of the multi-level storage structure.

3. The automated order fulfillment facility of claim 1, wherein the second tote handling device is configured to move vertically within the frame to support the one or more second totes at different vertical positions in the multi-level storage structure.

4. The automated order fulfillment facility of claim 1, wherein the first and second tote handling devices are coordinated to move vertically within the frame to store the first tote at different vertical positions of the plurality of support locations vertically oriented within the frame.

5. The automated order fulfillment facility of claim 1, wherein the first tote handling device is further configured to transfer a third tote from a storge location of a plurality of support locations to the multi-level storage structure.

6. The automated order fulfillment facility of claim 1, wherein the mobile robot is configured to store the first tote at a storage location of the plurality of storage locations once the first tote is acquired.

7. The automated order fulfillment facility of claim 1, further comprising a workstation positioned remotely from the multi-level storage structure, wherein the mobile robot is configured to travel between the multi-level storage structure and the workstation.

8. The automated order fulfillment facility of claim 7, wherein the first tote handling device is configured to transfer totes to and from the workstation.

9. The automated order fulfillment facility of claim 1, wherein the first tote bears the weight of the one or more second totes while the first tote and the one or more second totes are supported in the multi-level storage structure.

10. The automated order fulfillment facility of claim 1, wherein the plurality of racks are separated by aisles, and wherein the mobile robot is configured to move within the aisles.

11. A method of fulfilling orders, comprising:
transporting, by a mobile robot, totes to and from a multi-level storage structure comprising a plurality of racks, each rack configured to store a plurality of vertically stacked totes;
controlling a first tote handling device and extending a first portion of the first tote handling device from a frame of the mobile robot;
acquiring, by the first portion while extended, a first tote from the multi-level storage structure
controlling a second tote handling device and extending a second portion of the second tote handling device from the frame; and
supporting, by the extended second portion of the second tote handling device, one or more second totes above the first tote as the first tote is being acquired by the first portion of the first tote handling device.

12. The method of claim 11, further comprising:
controlling the first tote handling device and moving, prior to the acquiring the first tote, the first tote handling device vertically within the frame to a first vertical position within the multi-level storage structure of the first tote.

13. The method of claim 11, further comprising:
controlling the second tote handling device and moving, prior to the supporting of the one or more second totes, the second tote handling device vertically within the frame to a second vertical position within the multi-level storage structure different than the first vertical position.

14. The method of claim 11, further comprising:
controlling the first tote handling device and the second tote handling device to moving, after the acquiring the first tote, vertically within the frame and storing the first tote within a first support location of a plurality of support locations vertically oriented within the frame.

15. The method of claim 11, further comprising:
controlling the first tote handling device to transfer a third tote from a first support location, of a plurality of support locations vertically oriented within the frame, to the multi-level storage structure.

16. The method of claim 11, further comprising:
controlling the first tote handling device and moving, after the acquiring the first tote, the first tote handling device vertically within the frame to a third vertical position within the frame corresponding to a first support location of a plurality of support locations vertically oriented within the frame; and
controlling the first tote handling device to store the first tote in the first support location.

17. The method of claim 11, further comprising:
controlling the mobile robot to travel between the multi-level storage structure and a workstation positioned remotely from the multi-level storage structure.

18. The method of claim 17, further comprising:
controlling the first tote handling device to transfer a first plurality of retrieved totes, comprising the first tote, to the workstation;
controlling the first tote handling device to transfer a second plurality of totes from the workstation; and
storing each of the second plurality of totes into a different one of a plurality of support locations vertically oriented within the frame.

19. The method of claim 11, wherein the first tote bears the weight of the one or more second totes while the first tote and the one or more second totes are supported in the multi-level storage structure.

20. The method of claim 11, wherein the plurality of racks are separated by aisles and further comprising controlling the mobile robot to travel along a first aisle of the aisles.
